(19) United States
(12) Patent Application Publication
(10) Pub. No.: US 2022/0036878 A1
(43) Pub. Date: Feb. 3, 2022

(54) SPEECH ASSESSMENT USING DATA FROM EAR-WEARABLE DEVICES

(71) Applicant: Starkey Laboratories, Inc., Eden Prairie, MN (US)

(72) Inventors: Nicole Cyr, Denver, CO (US); Karrie Recker, Edina, MN (US); Dean G. Meyer, Mound, MN (US); Jeffery Lee Crukley, Ontario (CA)

(21) Appl. No.: 17/443,756

(22) Filed: Jul. 27, 2021

Related U.S. Application Data
(60) Provisional application No. 63/059,489, filed on Jul. 31, 2020.
(60) Provisional application No. 63/161,806, filed on Mar. 16, 2021.

(51) Int. Cl. G10L 15/02; G10L 25/27; G06N 20/00; G09B 19/04

(52) U.S. Cl. CPC G10L 15/02; G09B 19/04; G06N 20/00; G10L 25/27

(57) ABSTRACT

A computing system may store user profile information of a user of an ear-wearable device, where the user profile information includes parameters that control operation of the ear-wearable device. The computing system may also obtain audio data from one or more sensors that are included in the ear-wearable device and determine whether to generate speech assessment data based on the user profile information of the user and audio data. In some examples, the computing system may compare one or more acoustic parameters determined based on the audio data with an acoustic criterion determined based on the user profile information of the user. If one or more acoustic parameters satisfy the acoustic criterion, the computing system may generate speech assessment data based on the determination.

This application claims the benefit of U.S. Provisional Patent Application 63/059,489, filed Jul. 31, 2020, and U.S. Provisional Patent Application 63/161,806, filed Mar. 16, 2021, the entire content of each of which is incorporated by reference.

### TECHNICAL FIELD

This disclosure relates to ear-wearable devices.

### BACKGROUND

Abnormal speech, language, vocal and sociability skills can be caused by, or co-exist with, hearing loss. For example, a child who is born with hearing loss may have delayed speech and language skills and may therefore be less sociable. Similarly, an older adult with hearing loss who has had a stroke, or who is suffering from age-related cognitive decline, may have poorer speech language skills, poorer vocal quality, and be less sociable, than his or her peers. In these instances, and others, the individual or a caregiver may benefit from feedback on the individual's speech and language skills, vocal quality and sociability.

### SUMMARY

Among other techniques, this disclosure describes techniques for improving the speech assessment efficiency of a computing system. As described herein, a computing system may store user profile information of a user of an ear-wearable device, where the user profile information includes parameters that control the operation of the ear-wearable device. The computing system may also obtain audio data from one or more sensors that are included in the ear-wearable device and determine whether to generate speech assessment data based on the user profile information of the user and audio data. In some examples, the computing system may compare one or more acoustic parameters determined based on the audio data with an acoustic criterion determined based on the user profile information of the user. If one or more acoustic parameters satisfy the acoustic criterion, the computing system may generate speech assessment data based on the determination.

In one example, this disclosure describes a method comprising: storing user profile information of a user of an ear-wearable device, wherein the user profile information comprises parameters that control the operation of the ear-wearable device; obtaining audio data from one or more sensors that are included in the ear-wearable device; determining whether to generate speech assessment data based on the user profile information of the user and the audio data, wherein the speech assessment data provides information regarding speech of the user; and generating the speech assessment data based on the determination.

In another example, this disclosure describes a computing system comprising: a data storage system configured to store data related to an ear-wearable device; and one or more processing circuits configured to: store user profile information of a user of the ear-wearable device, wherein the user profile information comprises parameters that control the operation of the ear-wearable device; obtain audio data from one or more sensors that are included in the ear-wearable device; determine whether to generate speech assessment data based on the user profile information of the user and the audio data, wherein the speech assessment data provides information regarding speech of the user; and generate the speech assessment data based on the determination.

In another example, this disclosure describes an ear-wearable device comprising one or more processors configured to: store user profile information of a user of the ear-wearable device, wherein the user profile information comprises parameters that control the operation of the ear-wearable device; obtain audio data from one or more sensors that are included in the ear-wearable device; determine whether to generate speech assessment data based on the user profile information of the user and the audio data, wherein the speech assessment data provides information regarding speech of the user; and generate the speech assessment data based on the determination.

In other examples, this disclosure describes a computer-readable data storage medium having instructions stored thereon that, when executed, cause one or more processing circuits to store user profile information of a user of the ear-wearable device, wherein the user profile information comprises parameters that control the operation of the ear-wearable device; obtain audio data from one or more sensors that are included in the ear-wearable device; determine whether to generate speech assessment data based on the user profile information of the user and the audio data, wherein the speech assessment data provides information regarding speech of the user; and generate the speech assessment data based on the determination.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 illustrates an example system for speech assessment in accordance with one or more aspects of this disclosure.

FIG. 2 is a block diagram illustrating example components of an ear-wearable device, in accordance with one or more aspects of this disclosure.

FIG. 3 is a block diagram illustrating example components of a computing device associated with a user of one or more ear-wearable devices, in accordance with one or more aspects of this disclosure.

FIG. 4 is a flowchart illustrating an example operation of a computing system for determining whether to generate speech assessment data based on data related to one or more ear-wearable devices, in accordance with one or more aspects of this disclosure.

FIG. 5 is a flowchart illustrating an example operation of a computing system for determining whether to generate speech assessment data based on audio data and user profile information of a user of one or more ear-wearable devices, in accordance with one or more aspects of this disclosure.

FIG. 6 is a flowchart illustrating an example operation of a computing system for generating feedback, in accordance with one or more aspects of this disclosure.

FIG. 7A is a chart illustrating example speech and language attributes and types of abnormal speech patterns determined based on the speech and language attributes, in accordance with one or more aspects of this disclosure.

FIG. 7B is a chart illustrating example speech and language attributes and various inputs and algorithms used to assess these speech and language attributes, in accordance with the techniques of this disclosure.

FIG. 7C is a flowchart illustrating an example operation of a computing system for determining a potential type of abnormal speech patterns and generating one or more recommendations, in accordance with one or more aspects of this disclosure.

FIG. 7D is an overview diagram illustrating an example operation of a computing system using various algorithms to analyze audio data, in accordance with one or more aspects of this disclosure.

FIG. 8 is a flowchart illustrating an example operation of a computing system for generating speech assessment data based on a normative speech profile, in accordance with one or more aspects of this disclosure.

FIG. 9A is a flowchart illustrating an example operation of a system for generating a speech score, in accordance with one or more aspects of this disclosure.

FIG. 9B is a flowchart illustrating another example operation of a system for comparing a speech score with a historical speech score, in accordance with one or more aspects of this disclosure.

### DETAILED DESCRIPTION

Ear-wearable devices, such as hearing aids, are developed to enable people to hear things that they otherwise cannot. For example, hearing aids may improve the hearing comprehension of individuals who have hearing loss. Other types of ear-wearable devices may provide artificial sound to users. This disclosure describes examples of systems and methods for determining whether to generate speech assessment data based on data related to one or more ear-wearable devices.

In some examples, a computing system may be configured to receive data related to one or more ear-wearable devices. The data related to the one or more ear-wearable devices may include user profile information of a user of the one or more ear-wearable devices, where the user profile information includes parameters that control operation of the one or more ear-wearable devices (e.g., one or more ear-wearable device settings, one or more duty cycles for the one or more ear-wearable device setting, etc.). The data related to the one or more ear-wearable devices may further include audio data received from one or more sensors that are included in the ear-wearable device. By obtaining the user profile information of the user and the audio data, a computing system may determine whether to generate speech assessment data based on the obtained data. The computing system may further generate the speech assessment data in response to the determination.

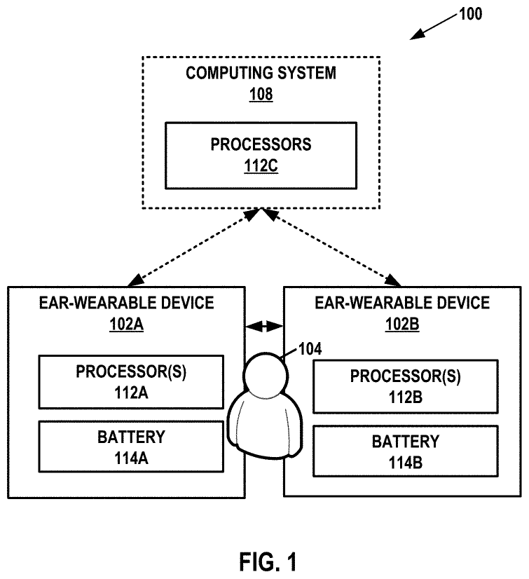

FIG. 1 illustrates an example system 100 for generating speech assessment data using data related to one or more ear-wearable devices, implemented in accordance with one or more aspects of this disclosure. In the example of FIG. 1, system 100 includes ear-wearable devices 102A and 102B (collectively, “ear-wearable devices 102”). A user 104 may wear ear-wearable devices 102. In some instances, such as when user 104 has unilateral hearing loss, user 104 may wear a single ear-wearable device. In other instances, such as when user 104 has bilateral hearing loss, user 104 may wear two ear-wearable devices, with one ear-wearable device for each ear of user 104. However, it should be understood that user 104 may wear a single ear-wearable device even if user 104 has bilateral hearing loss.

Ear-wearable device(s) 102 may comprise one or more of various types of devices configured to provide hearing assistance. For example, ear-wearable device(s) 102 may comprise one or more hearing assistance devices. In another example, ear-wearable device(s) 102 may comprise one or more Personal Sound Amplification Products (PSAPs). In another example, ear-wearable device(s) 102 may comprise one or more cochlear implants, cochlear implant magnets, cochlear implant transducers, and cochlear implant processors. In another example, ear-wearable device(s) 102 may comprise one or more so-called “hearables” that provide various types of functionality. In other examples, ear-wearable device(s) 102 may comprise other types of devices that are wearable in, on, or in the vicinity of the user's ears. In some examples, ear-wearable device(s) 102 may comprise other types of devices that are implanted or otherwise osseointegrated with the user's skull; wherein the ear-wearable device is able to facilitate stimulation of the wearer's ears via the bone conduction pathway. The techniques of this disclosure are not limited to the form of ear-wearable device shown in FIG. 1. Furthermore, in some examples, ear-wearable device(s) 102 include devices that provide auditory feedback to user 104. For instance, ear-wearable device(s) 102 may include so-called “hearables,” earbuds, earphones, or other types of devices.

In some examples, one or more of ear-wearable device(s) 102 includes a housing or shell that is designed to be worn in the ear for both aesthetic and functional reasons and encloses the electronic components of the ear-wearable device. Such ear-wearable devices may be referred to as in-the-ear (ITE), in-the-canal (ITC), completely-in-the-canal (CIC), or invisible-in-the-canal (IIC) devices. In some examples, one or more of ear-wearable device(s) 102 may be behind-the-ear (BTE) devices, which include a housing worn behind the ear that contains all of the electronic components of the ear-wearable device, including the receiver (i.e., the speaker). The receiver conducts sound to an earbud inside the ear via an audio tube. In some examples, one or more of ear-wearable device(s) 102 may be receiver-in-canal (RIC) hearing-assistance devices, which include a housing worn behind the ear that contains electronic components and a housing worn in the ear canal that contains the receiver.

Ear-wearable device(s) 102 may implement a variety of features that help user 104 hear better. For example, ear-wearable device(s) 102 may amplify the intensity of incoming sound, amplify the intensity of certain frequencies of the incoming sound, or translate or compress frequencies of the incoming sound. In another example, ear-wearable device(s) 102 may implement a directional processing mode in which ear-wearable device(s) 102 selectively amplify sound originating from a particular direction (e.g., to the front of user 104) while potentially fully or partially canceling sound originating from other directions. In other words, a directional processing mode may selectively attenuate off-axis unwanted sounds. The directional processing mode may help user 104 understand conversations occurring in crowds or other noisy environments. In some examples, ear-wearable device(s) 102 may use beamforming or directional processing cues to implement or augment directional processing modes.

In some examples, ear-wearable device(s) 102 may reduce noise by canceling out or attenuating certain frequencies. Furthermore, in some examples, ear-wearable device(s) 102 may help user 104 enjoy audio media, such as music or sound components of visual media, by outputting sound based on audio data wirelessly transmitted to ear-wearable device(s) 102.

Ear-wearable device(s) 102 may be configured to communicate with each other. For instance, in any of the examples of this disclosure, ear-wearable device(s) 102 may communicate with each other using one or more wirelessly communication technologies. Example types of wireless communication technology include Near-Field Magnetic Induction (NFMI) technology, a 900 MHz technology, a BLUETOOTH™ technology, a WI-FI™ technology, audible sound signals, ultrasonic communication technology, infrared communication technology, an inductive communication technology, or another type of communication that does not rely on wires to transmit signals between devices. In some examples, ear-wearable device(s) 102 use a 2.4 GHz frequency band for wireless communication. In some examples of this disclosure, ear-wearable device(s) 102 may communicate with each other via non-wireless communication links, such as via one or more cables, direct electrical contacts, and so on.

As shown in the example of FIG. 1, system 100 may also include a computing system 108. In other examples, system 100 does not include computing system 108. Computing system 108 comprises one or more computing devices, each of which may include one or more processors. For instance, computing system 108 may comprise one or more mobile devices, server devices, personal computer devices, handheld devices, wireless access points, smart speaker devices, smart televisions, medical alarm devices, smart key fobs, smartwatches, smartphones, motion or presence sensor devices, smart displays, screen-enhanced smart speakers, wireless routers, wireless communication hubs, prosthetic devices, mobility devices, special-purpose devices, accessory devices, and/or other types of devices. Accessory devices may include devices that are configured specifically for use with ear-wearable device(s) 102. Example types of accessory devices may include charging cases for ear-wearable device(s) 102, storage cases for ear-wearable device(s) 102, media streamer devices, phone streamer devices, external microphone devices, remote controls for ear-wearable device(s) 102, and other types of devices specifically designed for use with ear-wearable device(s) 102. Actions described in this disclosure as being performed by computing system 108 may be performed by one or more of the computing devices of computing system 108. One or more ear-wearable device(s) 102 may communicate with computing system 108 using wireless or non-wireless communication links. For instance, ear-wearable device(s) 102 may communicate with computing system 108 using any of the example types of communication technologies described elsewhere in this disclosure.

In the example of FIG. 1, ear-wearable device 102A includes one or more processors 112A and a battery 114A. Ear-wearable device 102B includes one or more processors 112B and a battery 114B. Computing system 106 includes a set of one or more processors 112C. Processors 112C may be distributed among one or more devices of computing system 106. This disclosure may refer to processors 112A, 112B, and 112C collectively as “processors 112.” Processors 112 may be implemented in circuitry and may include microprocessors, application-specific integrated circuits, digital signal processors, or other types of circuits. This disclosure may refer to battery 114A and battery 114B collectively as “batteries 114.”

As noted above, ear-wearable devices 102A, 102B, and computing system 108 may be configured to communicate with one another. Accordingly, processors 112 may be configured to operate together as a processing system. Thus, discussion in this disclosure of actions performed by a processing system may be performed by one or more processors in one or more of ear-wearable device 102A, ear-wearable device 102B, or computing system 106, either separately or incoordination. Moreover, it should be appreciated that, in some examples, the processing system does not include each of processors 112A, 112B, or 112C. For instance, the processing system may be limited to processors 112A and not processors 112B or 112C; or the processing system may include processors 112C and not processors 112A or 112B; or other combinations. Although this disclosure primarily describes computing system 108 as performing actions to determine the battery life of batteries 114, it should be appreciated that such actions may be performed by one or more, or any combination of processors 112, in this processing system.

Components of ear-wearable device 102A, including processors 112A, may draw power for battery 114A. Components of ear-wearable device 102B, including processors 112B, may draw power for battery 114B. Batteries 114 may include rechargeable batteries, such as lithium-ion batteries, or other types of batteries.

In children with hearing loss, the brain does not receive all the sounds that are required to develop normal speech and language. Additionally, children with or without hearing loss may experience abnormalities in their speech such as stuttering or lisping. At the same time, adults with hearing loss may experience health-related issues (e.g., cognitive decline or strokes) that can lead to speech and language difficulties and changes in vocal quality. For instance, those experiencing cognitive decline may ask for repetition more than those without cognitive decline, because they have difficulty remembering the answers. Additionally, someone who has had a stroke may experience aphasia, which can lead to difficulty speaking, reading, writing, and understanding others. For all of these individuals (and others), the combination of hearing loss and poorer communication skills, can lead to reduced sociability.

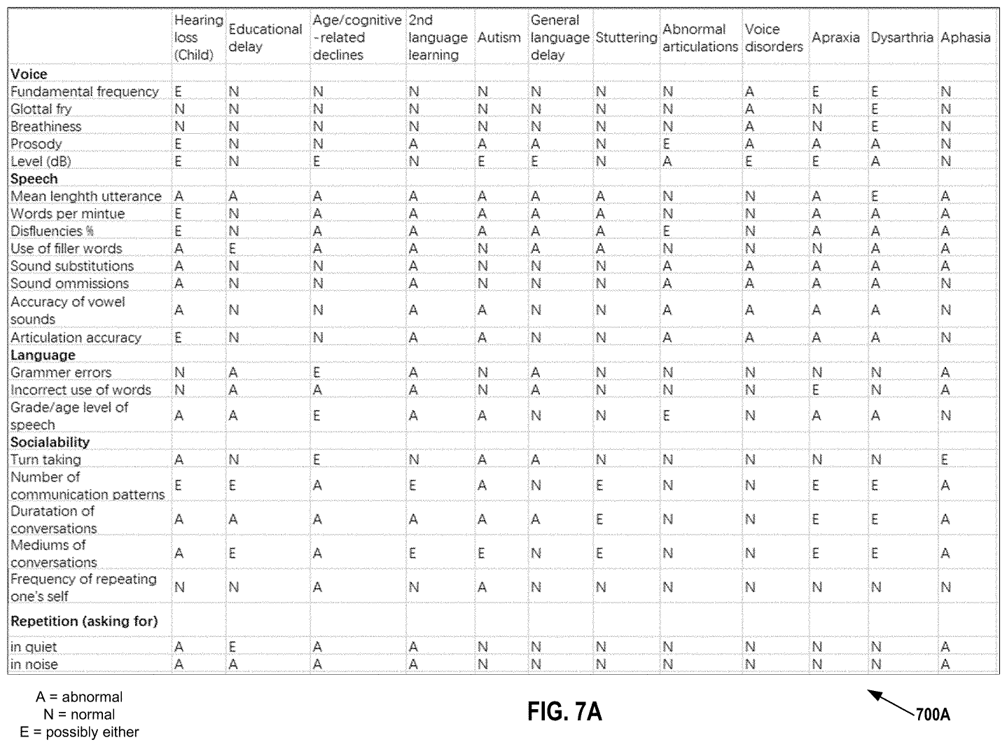

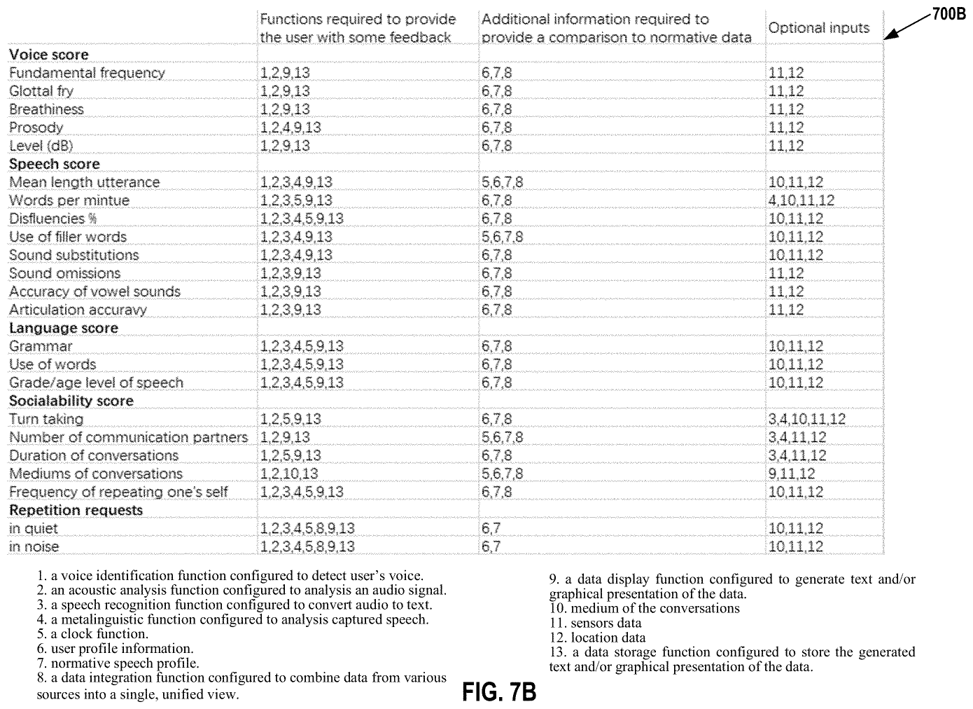

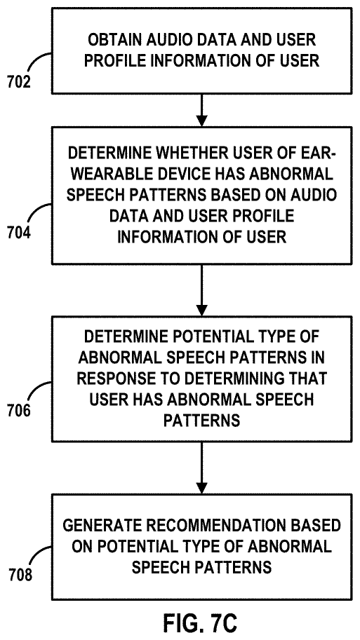

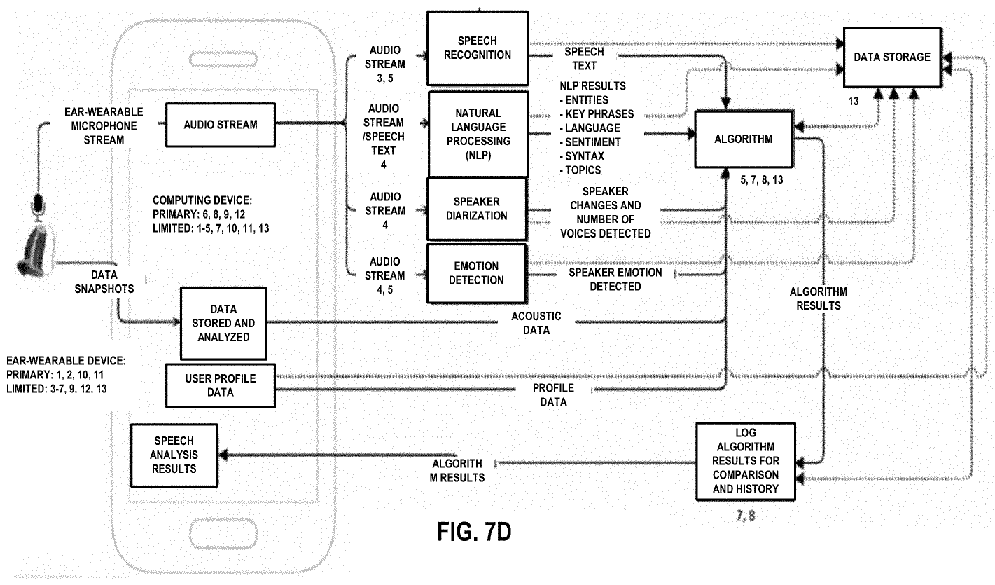

Examples of speech pathologies include stuttering (e.g., speech that is broken by repetitions, prolongations, or abnormal stoppages of sounds and syllables), lisping (e.g., a speech impediment characterized by misarticulation of sibilants such as the /s/ sound), sound omissions or substitutions and inaccurate vowel sounds and articulation errors. Examples of vocal abnormalities include glottal fry (e.g., low-frequency popping or rattling sounds caused by air passing through the glottal closure) and breathiness of speech. Examples or language errors include grammar errors and the incorrect use of words in context or word order. Each disorder, such as apraxia (e.g., an impaired ability to plan the motor movements of the lips, tongue, jaw, etc. that are needed to produce clear speech), dysarthria (e.g., an inability to reproduce appropriate patterns of articulatory movements, although other movements of the mouth and tongue appear normal when tested individually) and aphasia (e.g., an impairment of language affecting the production or comprehension of speech caused by a brain injury) may cause abnormalities across a range of speech, voice, language and sociability attributes (as shown in FIG. 7A). Apraxia, dysarthria and aphasia are examples of disorders; many other disorders and conditions exist for which individuals (or their caregivers) may appreciate feedback on their speech and language skills (e.g., those learning a second language, public speakers, etc.). Therefore, it is desirable to develop a system that is capable of monitoring users' speech and generating speech assessment data.

However, continuously generating speech assessment data at ear-wearable device(s) 102 may consume considerable amounts of battery power, which may be in limited supply in ear-wearable device(s) 102. This disclosure describes techniques for using user profile information of user 104 audio data, and other data to determine whether to generate speech assessment data. Selectively generating speech assessment data may help conserve battery power. Additionally, selectively generating speech assessment data may help reduce the generation of data that could pose privacy concerns and whose wireless transmission may cause further drains on battery power.

Furthermore, not all auditory or communication situations in which user 104 is engaged are equally indicative of the user's speech and language skills. For example, audio data collected in a noisy environment may be considered as a relatively lower-quality communication situation than audio data collected in a quiet environment as speech may not be perceived in a noisy environment.

In some examples, a speech assessment system may be implemented on ear-wearable device(s) 102 and/or computing system 108. The speech assessment system may generate speech assessment data. The speech assessment data provides information about the speech and language skills of user 104. To avoid power consumption associated with continual evaluation of the speech and language skills of user 104, the speech assessment system may refrain from generating speech assessment data until one or more acoustic parameters determined based on the audio data satisfy one or more acoustic criteria. The one or more acoustic parameters indicate one or more characteristics of the audio data. For example, the one or more acoustic parameters may include a noise level of the audio data, a frequency band of the audio data, an estimated signal-to-noise ratio (SNR), an estimated amount of reverberation, and other acoustic parameters associated with the audio data, e.g., an acoustic environment of the audio data such as speech, another sound class (background noise, music, wind, machine noise, etc.), or the wearer's own voice. The one or more acoustic criteria are specified acoustic criteria for user 104. In some examples, the one or more acoustic criteria may be determined based on the user profile information of user 104. For example, the speech assessment system may generate speech assessment data when a noise level determined based on the audio data is at an acceptable level for speech analysis to occur. If the one or more acoustic parameters determined based on the audio data satisfy the acoustic criterion determined based on the user profile information of user 104, the speech assessment system may then generate speech assessment data based on the determination.

As described in greater detail elsewhere in this disclosure, speech assessment data may include advice regarding how to build speech and language skills for user 104. For example, if the speech assessment system determines user 104 has an incorrect pronunciation of a word, speech assessment data may include feedback that provides user 104 with the correct pronunciation of the word. In some examples, audible feedback may be provided directly from ear-wearable device(s) 102 to user 104, enabling the feedback to be completely hidden from others. In some examples, visible feedback may be provided to user 104 via an application on a user device. In some examples, vibrotactile feedback may be provided (e.g., from ear-wearable device(s) 102, a smart watch, a smartphone or another device). In another example, if the speech assessment system determines user 104 has abnormal speech patterns, speech assessment data may include a potential type of speech disorder and may include speech therapy tips for the potential type of speech disorder. In this example, the speech assessment system may use data from other users to generate speech therapy tips. In some examples, speech assessment data may include ratings of individual attributes (e.g., fundamental frequency, glottal fry, breathiness, prosody, level, etc.). In other examples, speech assessment data may include one or more speech scores indicating different speech and language attributes (e.g., voice, language, sociability, repetition, etc.) of the speech and language skills of user 104. In this example, the speech assessment system may use one or more of historical data of user 104 to generate and provide an overall tendency of the speech scores of user 104 over a period of time. In still other examples, assessment data may include all, or only a subset of, the speech assessment data. For example, in some instances it may be preferable to only display results for attributes that are likely to be abnormal for the individual rather than all of the results that are available. In other examples, it may be preferrable to display all of the results that are available.

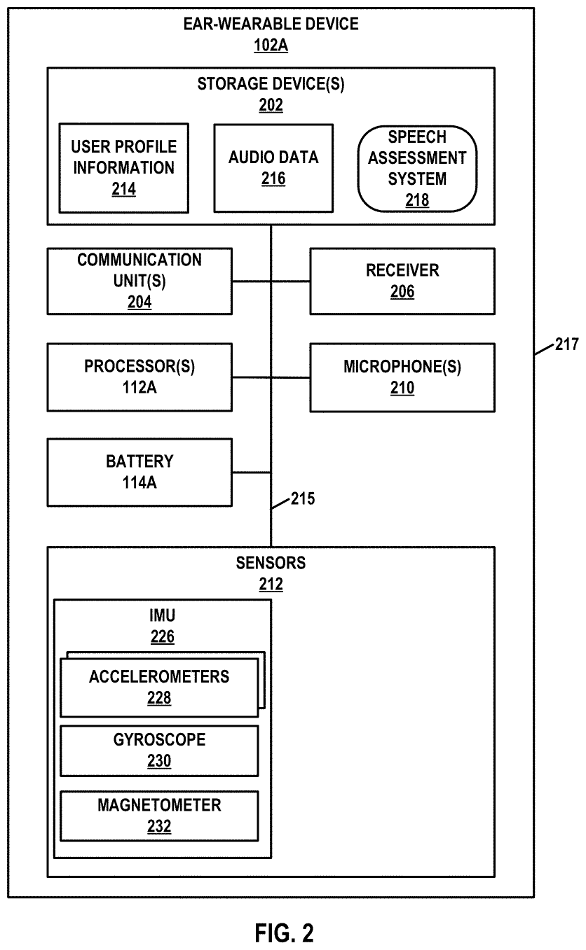

FIG. 2 is a block diagram illustrating example components of ear-wearable device 102A, in accordance with one or more aspects of this disclosure. Ear-wearable device 102B may include the same or similar components of ear-wearable device 102A shown in the example of FIG. 2. Thus, discussion of ear-wearable device 102A may apply with respect to ear-wearable device 102B.

In the example of FIG. 2, ear-wearable device 102A includes one or more storage devices 202, one or more communication units 204, a receiver 206, one or more processors 112A, one or more microphones 210, a set of sensors 212, a battery 114A, and one or more communication channels 215. Communication channels 215 provide communication between storage devices 202, communication unit(s) 204, receiver 206, processor(s) 112A, a microphone(s) 210, and sensors 212. Components 202, 204, 206, 112A, 210, and 212 may draw electrical power from battery 114A.

Battery 114A may include any suitable arrangement of disposable batteries, along with or in combination with rechargeable batteries, to provide electric power to storage devices 202, communication units 204, receiver 206, processors 112A, microphones 210, and sensors 212.

In the example of FIG. 2, each of components 202, 204, 206, 112A, 210, 212, 114A, and 215 are contained within a single housing 217. However, in other examples of this disclosure, components 202, 204, 206, 112A, 210, 212, 114A, and 215 may be distributed among two or more housings. For instance, in an example where ear-wearable device 102A is a RIC device, receiver 206 and one or more sensors 212 may be included in an in-ear housing separate from a behind-the-ear housing that contains the remaining components of ear-wearable device 102A. In such examples, a RIC cable may connect the two housings.

Furthermore, in the example of FIG. 2, sensors 212 include an inertial measurement unit (IMU) 226 that is configured to generate data regarding the motion of ear-wearable device 102A. IMU 226 may include a set of sensors. For instance, in the example of FIG. 2, IMU 226 includes one or more of accelerometers 228, a gyroscope 230, a magnetometer 232, combinations thereof, and/or other sensors for determining the motion of ear-wearable device 102A. Furthermore, in the example of FIG. 2, ear-wearable device 102A may include one or more additional sensors 236. Additional sensors 236 may include a photoplethysmography (PPG) sensor, blood oximetry sensors, blood pressure sensors, electrocardiograph (EKG) sensors, body temperature sensors, electromyography (EMG) sensors, electroencephalography (EEG) sensors, environmental temperature sensors, environmental pressure sensors, environmental humidity sensors, skin galvanic response sensors, and/or other types of sensors. In other examples, ear-wearable device 102A and sensors 212 may include more, fewer, or different components.

Storage devices 202 may store data. Storage devices 202 may comprise volatile memory and may therefore not retain stored contents if powered off. Examples of volatile memories may include random access memories (RAM), dynamic random access memories (DRAM), static random access memories (SRAM), and other forms of volatile memories known in the art. Storage devices 202 may further be configured for long-term storage of information as non-volatile memory space and may retain information after power on/off cycles. Examples of non-volatile memory configurations may include magnetic hard discs, flash memories, or forms of electrically programmable memories (EPROM) or electrically erasable and programmable (EEPROM) memories.

Communication unit(s) 204 may enable ear-wearable device 102A to send data to and receive data from one or more other devices, such as another ear-wearable device, an accessory device, a mobile device, or other types of device. Communication unit(s) 204 may enable ear-wearable device 102A using wireless or non-wireless communication technologies. For instance, communication unit(s) 204 may enable ear-wearable device 102A to communicate using one or more of various types of wireless technology, such as a BLUETOOTH™ technology, 3G, 4G, 4G LTE, 5G, ZigBee, WI-FI™, Near-Field Magnetic Induction (NFMI), ultrasonic communication, infrared (IR) communication, or another wireless communication technology. In some examples, communication unit(s) 204 may enable ear-wearable device 102A to communicate using a cable-based technology, such as a Universal Serial Bus (USB) technology.

Receiver 206 includes one or more speakers for generating audible sound. Microphone(s) 210 detects incoming sound and generates audio data (e.g., an analog or digital electrical signal) representing the incoming sound.

Processor(s) 112A may be processing circuits configured to perform various activities. For example, processor(s) 112A may process the signal generated by microphone(s) 210 to enhance, amplify, or cancel-out particular channels within the incoming sound. Processor(s) 112A may then cause receiver 206 to generate sound based on the processed signal. In some examples, processor(s) 112A includes one or more digital signal processors (DSPs). In some examples, processor(s) 112A may cause communication unit(s) 204 to transmit one or more of various types of data. For example, processor(s) 112A may cause communication unit(s) 204 to transmit data to computing system 108. Furthermore, communication unit(s) 204 may receive audio data from computing system 108, and processor(s) 112A may cause receiver 206 to output sound based on the audio data.

In the example of FIG. 2, storage device(s) 202 may store user profile information 214, audio data 216, and speech assessment system 218. Speech assessment system 218 may generate speech assessment data providing information about the speech and language skills of a user, such as user 104. User profile information 214 may include parameters that control the operation of speech assessment system 218. For example, ear-wearable device(s) 102 may store data indicating one or more ear-wearable device settings, duty cycles for the one or more ear-wearable device settings, and other values. The duty cycles manage the on and off time of the one or more ear-wearable device sittings. Processors 112A may obtain user profile information 214 from storage device(s) 202 and may operate based on user profile information 214. Additionally, storage device(s) 202 may store audio data 216 obtained from microphone(s) 210. For instance, processors 112A may determine whether to generate speech assessment data based on user profile information 214 and audio data 216. In some examples, processors 112A may send user profile information 214, audio data 216, and other data (e.g., the status of different ear-wearable device features (such as noise reduction, directional microphones), ear-wearable device settings (e.g., gain settings, a summary of which hardware is active in ear-wearable device(s) 102, etc.) sensor data (e.g., on heart rate, temperature, positional data, etc.) to computing system 108 in response to receiving a request for data from computing system 108. Computing system 108 may then determine whether to generate speech assessment data based on received data. In some examples, processors 112A may perform one or more aspects of the computing system 108.

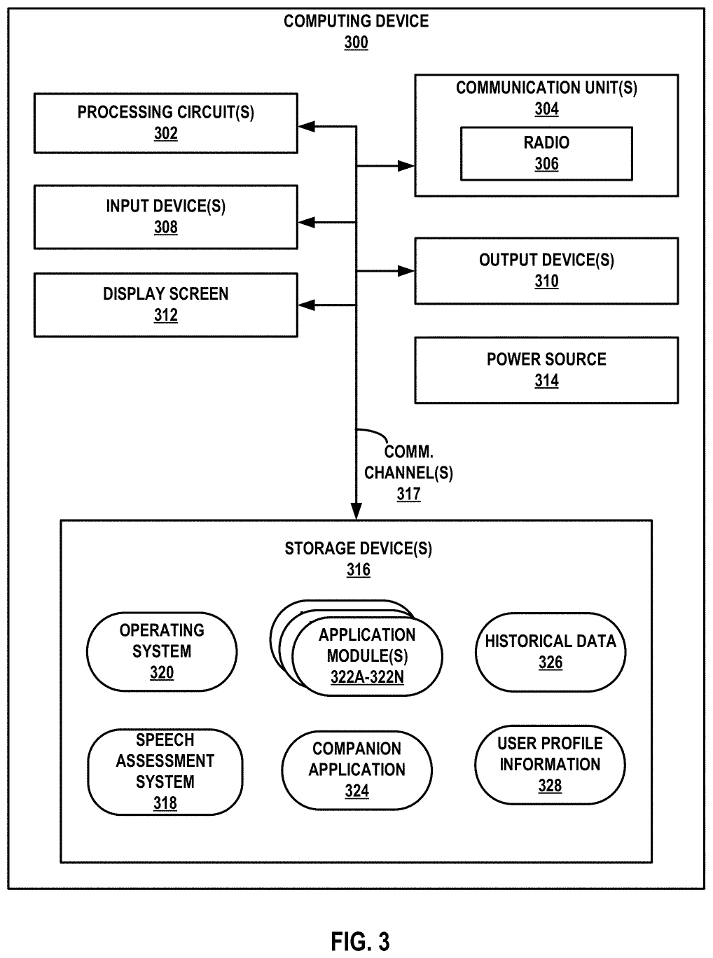

FIG. 3 is a block diagram illustrating example components of computing device 300, in accordance with one or more aspects of this disclosure. FIG. 3 illustrates only one particular example of computing device 300, and many other example configurations of computing device 300 exist. Computing device 300 may be a computing device in computing system 108 (FIG. 1).

As shown in the example of FIG. 3, computing device 300 includes one or more processor(s) 302, one or more communication unit(s) 304, one or more input device(s) 308, one or more output device(s) 310, a display screen 312, a power source 314, one or more storage device(s) 316, and one or more communication channels 317. Processors 112C (FIG. 1) may include processor(s) 302. Computing device 300 may include other components. For example, computing device 300 may include physical buttons, microphones, speakers, communication ports, and so on. Communication channel(s) 317 may interconnect each of components 302, 304, 308, 310, 312, and 316 for inter-component communications (physically, communicatively, and/or operatively). In some examples, communication channel(s) 317 may include a system bus, a network connection, an inter-process communication data structure, or any other method for communicating data. Power source 314 (e.g., a battery or other type of power supply) may provide electrical energy to components 302, 304, 308, 310, 312, and 316.

Storage device(s) 316 may store information required for use during the operation of computing device 300. In some examples, storage device(s) 316 have the primary purpose of being a short term and not a long-term computer-readable storage medium. In some examples, storage device(s) 316 may store user profile information. In some examples, user profile information may include some or all of the user profile information that is stored on ear-wearable device(s) 102. In some examples, user profile information may include information that is used to communicate to ear-wearable device(s) 102 when to start or stop speech assessment. In some examples, user profile information may include information about which analyses should be performed on captured audio data, and which data should be displayed to user 104 of ear-wearable device(s) 102. Storage device(s) 316 may be volatile memory and may therefore not retain stored contents if powered off. Storage device(s) 316 may further be configured for long-term storage of information as non-volatile memory space and may retain information after power on/off cycles. In some examples, processor(s) 302 of computing device 300 may read and execute instructions stored by storage device(s) 316.

Computing device 300 may include one or more input device(s) 308 that computing device 300 uses to receive user input. Examples of user input include tactile, audio, and video user input. Input device(s) 308 may include presence-sensitive screens, touch-sensitive screens, mice, keyboards, voice responsive systems, microphones, or other types of devices for detecting input from a human or machine.

Communication unit(s) 304 may enable computing device 300 to send data to and receive data from one or more other computing devices (e.g., via a communications network, such as a local area network or the Internet). For instance, communication unit(s) 304 may be configured to receive data exported by ear-wearable device(s) 102, receive data generated by user 104 of ear-wearable device(s) 102, receive and send request data, receive and send messages, and so on. In some examples, communication unit(s) 304 may include wireless transmitters and receivers that enable computing device 300 to communicate wirelessly with the other computing devices. For instance, in the example of FIG. 3, communication unit(s) 304 includes a radio 306 that enables computing device 300 to communicate wirelessly with other computing devices, such as ear-wearable device(s) 102 (FIG. 1). Examples of communication unit(s) 304 may include network interface cards, Ethernet cards, optical transceivers, radio frequency transceivers, or other types of devices that are able to send and receive information. Other examples of such communication units may include BLUETOOTH™, 3G, 4G, 5G, and WI-FI™ radios, Universal Serial Bus (USB) interfaces, etc. Computing device 300 may use communication unit(s) 304 to communicate with one or more ear-wearable devices (e.g., ear-wearable device(s) 102 (FIG. 1, FIG. 2)). Additionally, computing device 300 may use communication unit(s) 304 to communicate with one or more other remote devices.

Output device(s) 310 may generate output. Examples of output include tactile, audio, and video output. Output device(s) 310 may include presence-sensitive screens, sound cards, video graphics adapter cards, speakers, liquid crystal displays (LCD), or other types of devices for generating output.

Processor(s) 302 may read instructions from storage device(s) 316 and may execute instructions stored by storage device(s) 316. Execution of the instructions by processor(s) 302 may configure or cause computing device 300 to provide at least some of the functionality ascribed in this disclosure to computing device 300. As shown in the example of FIG. 3, storage device(s) 316 includes computer-readable instructions associated with speech assessment system 318, operating system 320, application modules 322A-322N (collectively, “application modules 322”), and a companion application 324. Additionally, in the example of FIG. 3, storage device(s) 316 may store historical data 326 and user profile information 328. In some examples, historical data 326 includes historical data related to user 104, such as one or more historical speech scores generated over a period of time. In some examples, user profile information 328 includes one or more of: demographic information, an acoustic profile of the own voice of user 104, data indicating the presence, status or settings of one or more pieces of hardware of ear-wearable device(s) 102, data indicating when a snapshot or speech assessment data should be generated, data indicating which analyses should be performed on captured audio data, data indicating which results should be displayed or sent to a companion computing device.

Execution of instructions associated with speech assessment system 318 may cause computing device 300 to perform one or more of various functions. In some examples, the execution of instructions associated with speech assessment system 318 may cause computing device 300 to store audio data and user profile information of a user (e.g., user 104) of an ear-wearable device (e.g., ear-wearable device(s) 102). The user profile information may include parameters that control the operation of the ear-wearable device, such as one or more ear-wearable device settings, one or more duty cycles for the one or more ear-wearable device settings, etc. The user profile information may also contain information about the voice of user 104 (e.g., about the fundamental frequency, formant relationships, etc.) that contributes to ear-wearable device(s) 102 to distinguishing the voice of user 104 from other voices. Execution of instructions associated with speech assessment system 318 may further cause computing device 300 to determine whether to generate speech assessment data based on the user profile information of the user and the audio data. Computing device 300 may further generate speech assessment data providing information about the speech and language skills of the user.

Execution of instructions associated with operating system 320 may cause computing device 300 to perform various functions to manage hardware resources of computing device 300 and to provide various common services for other computer programs. Execution of instructions associated with application modules 322 may cause computing device 300 to provide one or more of various applications (e.g., “apps,” operating system applications, etc.). Application modules 322 may provide particular applications, such as text messaging (e.g., SMS) applications, instant messaging applications, email applications, social media applications, text composition applications, and so on.

Execution of instructions associated with companion application 324 by processor(s) 302 may cause computing device 300 to perform one or more of various functions. Companion application 324 may be used as a companion to ear-wearable device(s) 102. In some examples, the execution of instruments associated with companion application 324 may cause computing device 300 to display speech assessment data for user 104 or one or more third parties. In one example, the speech assessment data may include a message indicating signs of a potential type of abnormal speech patterns and recommendations generated based on the potential type of abnormal speech patterns. In another example, the speech assessment data may include a historical graph indicating the speech and language skills development of user 104 over a period of time. The historical graph may be viewed with various display methodology such as line, area, bar, point, etc., at user's selection. In some examples, companion application 324 is an instance of a web application or server application. In some examples, such as examples where computing device 300 is a mobile device or other types of computing device, companion application 324 may be a native application.

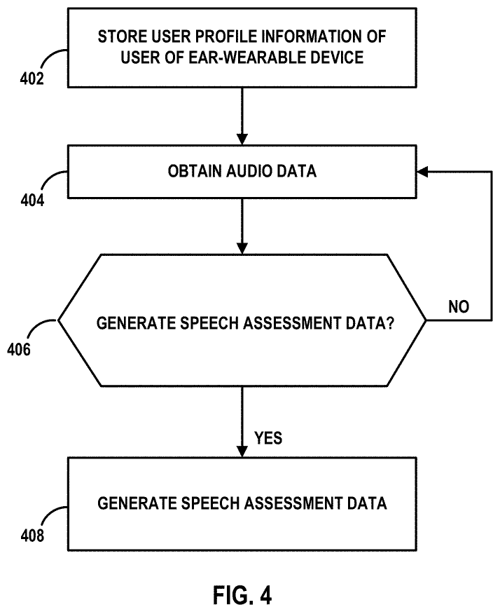

FIG. 4A is a flowchart illustrating an example operation for determining whether to generate speech assessment data based on data related to one or more ear-wearable devices, in accordance with one or more aspects of this disclosure. The flowcharts of this disclosure are provided as examples. In other examples, operations shown in the flowcharts may include more, fewer, or different actions, or actions may be performed in different orders or in parallel. In the example of FIG. 4, a speech assessment system, such as speech assessment system 218 (FIG. 2) and/or speech assessment system 318 (FIG. 3), may store user profile information of user 104 of ear-wearable device(s) 102 in a data storage system, such as storage device(s) 202 (FIG. 2) and/or storage device(s) 316 (FIG. 3) (402). User profile information 214 includes parameters that control the operation of ear-wearable device(s) 102. For instance, user profile information 214 may include any, all, or some combination of the following: the individual's hearing loss, instructions for when to start and stop speech assessment, instructions regarding which analyses should be performed on the audio data, data indicating the presence or status of one or more pieces of ear-wearable hardware, sensors, directional microphones, telecoils, etc., instructions for which data should be sent to computing device 300 and when/how frequently it should be sent. User profile information 214 may include device settings of ear-wearable device(s) 102, duty cycles for the one or more ear-wearable device settings, and other values. User profile information 328 may include all, or a subset of user profile information 214. Further, user profile information 328 may include any, all, or some combination of the following: additional demographic data, information about which analyses should be performed on the audio data (beyond that which is performed by ear-wearable device(s) 102), which data should be displayed to the individual, which normative data should be used for comparison, and which data should be sent to one or more third parties.

In some examples, ear-wearable device(s) 102 may receive an instruction provided by user 104 and/or a third party and store the instruction in user profile information 214. The instruction includes one or more of the following: an on instruction configured to turn-on analyses, an off instruction configured to turn-off the analyses, or an edit instruction configured to edit the analyses. For example, the user or third party may provide an edit instruction to manually delete a portion of the analyses should it be performed on the audio data.

In some examples, the ear-wearable device settings of user profile information 214 may include one or more conditions indicating the circumstances under which a snapshot and/or speech analysis should occur. A snapshot may include raw, unprocessed data that are captured by a microphone (e.g., captured from microphones 210 of ear-wearable device(s) 102), sensor 212 or other hardware by ear-wearable device(s) 102. A snapshot may include status information (e.g., whether a given feature, sensor or hardware is active or not), setting information (i.e., the current parameters associated with that feature, sensor, or hardware) or analyses performed by ear-wearable device(s) 102 on the raw data. Examples of these analyses may include: summaries of acoustic parameters, summaries of amplification settings (e.g., channel-specific gains, compression ratios, output levels, etc.), summaries of features that are active in ear-wearable device(s) 102 (e.g., noise reduction, directional microphones, frequency lowering, etc.), summaries of sensor data (e.g., IMU, EMG, etc.), which may contribute all, or in part, to activity classification (e.g., whether the individual is walking, jogging, biking, talking, eating, etc.), summaries of other hardware (e.g., telecoil, microphone, receiver, wireless communications, etc.), and summaries of other parameters and settings that are active or available on ear-wearable device(s) 102 (e.g., battery status, time stamp, etc.).

Speech assessment system 218 may allow manual or automatic recording of audio and analyzing captured audio. Audio may reflect a specific time, location, event, or environment. For example, a church bell sound may indicate a specific time during a day, and a siren sound may indicate an emergency event. Collectively, the captured audio can represent an ensemble audio experience. In some examples, user 104 of ear-wearable device(s) 102 may selectively capture audio and/or other data and tag captured data with a specific experience at a specific time and place. In other examples, speech assessment system 218 may automatically capture a snapshot and/or initiate speech analysis of the captured snapshot based on one or more conditions.

The one or more conditions indicating the circumstances under which a snapshot or speech analysis should occur may include: a time interval, whether a certain sound class or an acoustic characteristic is identified based on captured audio data, whether a specific activity is detected based on the captured audio and/or sensor data, whether a specific communication medium is being used (e.g., whether ear-wearable device(s) 102 are in their default acoustic mode, telecoil mode, or whether ear-wearable device(s) 102 are streaming audio wirelessly from a phone or other sound source), whether a certain biometric threshold has been passed, whether ear-wearable device(s) 102 are at a geographic location, or whether a change is detected in any of these categories or some combination thereof.

In some examples, speech assessment system 218 may take snapshots and/or perform speech analysis based on a time interval. The time interval may be fixed or random intervals during specific days or times of the day. For example, speech assessment system 218 may take snapshots and/or perform speech analysis every 15 minutes during a time interval in which user 104 is likely to talk, such as between 9:00 am to 3:00 pm from Monday to Friday.

In some examples, speech assessment system 218 may take snapshots and/or perform speech analysis based on a sound class detected by microphone(s) 210. The sound class may include the own voice of user 104, voice of others, music sound, wind sound, machine noise, etc. For example, speech assessment system 218 may initiate a speech analysis when the voice of user 104 is present.

In some examples, speech assessment system 218 may take snapshots and/or perform speech analysis based on an acoustic characteristic. The acoustic characteristic may include whether a captured audio has passed a certain decibel level, whether the audio has an acceptable SNR, whether the audio has certain frequencies present in the audio, or whether the audio has a certain frequency response or pattern. For example, speech assessment system 218 may initiate speech analysis when a noise level determined based on the audio is at an acceptable noise level for speech analysis to occur.

In some examples, speech assessment system 218 may take snapshots and/or perform speech analysis based on an activity detected by one or more sensors. For example, speech assessment system 218 may use one or more EMG sensors to detect jaw movement suggesting that user 104 may be about to talk and may take a snapshot based on the detection of jaw movement.

In some examples, speech assessment system 218 may take snapshots and/or perform speech analysis based on a condition indicating whether a specific communication medium is being used by user 104. The condition indicating whether a specific communication medium is being used may include whether a captured sound is live, from a telecoil, or streamed from an electronic device such as a smartphone, television, or computer. For example, speech assessment system 218 may take a snapshot based on determining the captured sound is from telecoil, indicating that user 104 may be talking or about to talk.

In some examples, speech assessment system 218 may take snapshots and/or perform speech analysis based on a determination of whether a biometric threshold has been passed. The determination of whether the biometric threshold has been passed may be based on inputs from an IMU, photoplethysmography (PPG) sensors, blood oximetry sensors, blood pressure sensors, electrocardiograph (EKG) sensors, body temperature sensors, electroencephalography (EEG) sensors, environmental temperature sensors, environmental pressure sensors, environmental humidity sensors, skin galvanic response sensors, electromyography (EMG) sensors, and/or other types of sensors.

Time intervals, sound classes, acoustic characteristics, user activities, communication mediums, and biometric thresholds may be determined all, or in part, by ear-wearable device(s) 102. An external device, such as a smartphone, may determine geographic and/or time information and use the geographic and/or time information to trigger a snapshot or speech analysis from ear-wearable device(s) 102. An external device may also store and/or analyze any of the acoustic, sensor, biometric data, or other data captured by or stored on ear-wearable device(s) 102.

In some examples, user profile information 214 and/or user profile information 328 includes information about user 104 of ear-wearable device(s) 102. For example, user profile information 214 and/or user profile information 328 may include demographic information, an acoustic profile of the own voice of user 104, data indicating presence of user 104, hardware settings of ear-wearable device(s) 102, data indicating when snapshot or speech assessment data should be generated, data indicating which analyses should be performed on captured audio data, data indicating which results should be displayed or sent to a companion computing device.

In some examples, the demographic information includes one or more of: age, gender, geographic location, place of origin, native language, language that is being learned, education level, hearing status, socio-economic status, health condition, fitness level, speech or language diagnosis, speech or language goal, treatment type, or treatment duration of user 104.

In some examples, the acoustic profile of the own voice of user 104 includes one or more of: the fundamental frequency of user 104, or one or more frequency relationships of sounds spoken by user 104. For example, the one or more frequency relationships may include formants and formant transitions.

In some examples, the hardware settings of ear-wearable device(s) 102 includes one or more of: a setting of the one or more sensors, a setting of microphones, a setting of receivers, a setting of telecoils, a setting of wireless transmitters, a setting of wireless receivers, or a setting of batteries of ear-wearable device(s) 102.

In some examples, the data indicating when the snapshot or the speech assessment data should be generated includes one or more of: a specified time or a time interval, whether a sound class or an acoustic characteristic is identified, whether a specific activity is detected, whether a certain communication medium is detected, whether a certain biometric threshold has been passed, or whether a specific geographic location is entered.

In some examples, the snapshot generated by ear-wearable device(s) 102 includes one or more of: unprocessed data from the ear-wearable device or analyses that have been performed by ear-wearable device(s) 102. In some examples, the analyses that have been performed by ear-wearable device(s) 102 includes one or more of: summaries of the one or more acoustic parameters, summaries of amplification settings, summaries of features and algorithms that are active in ear-wearable device(s) 102, summaries of sensor data, or summaries of the hardware settings of ear-wearable device(s) 102.

In some examples, user profile information 214 and/or user profile information 328 may include information about the speech and language analyses that speech assessment system 218 may perform, which may be determined by a manufacturer of ear-wearable device(s) 102, user 104, a third party, or some combination thereof. In some examples, the analysis options may include an option to determine whether the speech and language skills of user 104 change over time, with the sound class that is detected, with the acoustic characteristics, with the user's activities, with the communication medium, with biometric data of user 104, with the geographic location, etc.

In some examples, user profile information 214 and/or user profile information 328 may include information about the level of detail of results of the speech analysis of captured audio that user 104 or a third party may receive, which may be determined by the manufacturer of ear-wearable device(s) 102, user 104, a third party, or some combination thereof. In some examples, user 104 and the third party may receive results of the speech analysis of captured audio with different levels of detail. In some examples, user profile information 214 and/or user profile information 328 may include preferences about the level of detail of the results of the speech analysis of captured audio user 104 would like to receive. For example, user 104 may prefer to receive a composite “voice” score, whereas a care provider may prefer to receive for individual metrics such as fundamental frequency, glottal fry, breathiness, etc.

In some examples, user profile information 214 and/or user profile information 328 may include one or more normative speech profile, and speech assessment system 218 may compare the results of the speech analysis of captured audio with the one or more normative speech profile. In some examples, speech assessment system 218 may compare one or more data included in the results of the speech analysis of captured audio with one or more data included in the one or more normative speech profile. In some examples, one or more data may be selected by the manufacturer of ear-wearable device(s) 102, user 104, a third party, or some combination thereof.

In some examples, user profile information 214 and/or user profile information 328 may include information about how frequently the snapshots or speech analysis should occur, which may be determined by a manufacturer of ear-wearable device(s) 102, user 104, a third party, or some combination thereof. For example, the snapshots or speech analysis may occur at fixed, random, or specified intervals and/or during specific days or times of the day; for example, every 15 minutes Monday-Friday 9 a.m. to 3 p.m. In some examples, speech analysis frequency may be changed based on a desire to see data in real-time, which may increase data transfer between ear-wearable device(s) 102 and an external device, or a desire to conserve battery life, which may decrease data transfer between ear-wearable device(s) 102 and the external device.

In some examples, user 104 has the ability to override the user profile and manually turn on or off speech analysis. In some examples, user 104 has the ability to delete a portion of the speech analysis, for example, for privacy reasons. In some examples, user 104 may determine the amount of time for which the data should be deleted (e.g., 5 minutes, an hour, a day, etc.). In some examples, speech assessment system 218 may perform every speech and language analysis that is available in response to each speech signal. In other examples, speech assessment system 218 may perform a subset of analyses. The subset of analyses may focus on key speech and language attributes that are likely to be abnormal for user 104, or analyses that are generally of interest to user 104, the manufacturer of ear-wearable device(s) 102, or another third party.

Ear-wearable device(s) 102 may perform 0-100% of the speech analysis and may send the audio signal and/or results of the speech analysis of captured audio to a secondary device (e.g., a smartphone) for additional data analysis, data storage, and data transfer to cloud-based servers and libraries. Ear-wearable device(s) 102 may also send information to the secondary device about the circumstances under which the speech sample was captured. The information about the circumstances under which the speech sample was captured may include information about the acoustics of the environment, the pieces of hardware that were active in ear-wearable device(s) 102, the algorithms that were active in ear-wearable device(s) 102, the activities that were detected, the medium of the conversation, biometric data, timestamps, etc.

The secondary device may send information about the geographic location and/or the results of any analyses that the secondary device has performed on the received data to the cloud-based servers. The cloud-based servers may then perform additional analyses on and storage of the received data. The analyses may compare the user's results to his/her historical data, and/or to those of his/her peers who is undergoing similar or different treatments. Further, the cloud-based servers may examine how the user's speech patterns vary with time, the acoustic environment, the features that were active on ear-wearable device(s) 102, the activities that were detected, the medium of the conversation, biometric data, geographic location, etc. The secondary device or on the cloud-based server(s) may then perform data integration to combine one or more results of the speech analysis into a combined, unified result.

The speech assessment system may also obtain audio data (404) and store the obtained audio data in a data storage system, such as storage device(s) 202 (FIG. 2) and/or storage device(s) 316 (FIG. 3). For instance, in some examples, the speech assessment system may obtain audio data from a data storage system, from a computer-readable medium, directly from a sensor (e.g., microphone 210 (FIG. 2), or otherwise obtain audio data.

In some examples, the speech assessment system may obtain audio data from microphone(s) 210 over time. In some examples, the speech assessment system may obtain audio data from microphone(s) 210 every second, every minute, hourly, daily, etc., or may obtain audio data from microphone(s) 210 in an aperiodic fashion. For example, the speech assessment system may be preconfigured to control microphone(s) 210 to perform audio recording every twenty minutes for a predetermined number of hours, such as between 8 a.m. and 5 p.m. As another example, user 104 may manually control the speech assessment system to obtain audio data from microphone(s) 210 to perform random audio recording at random times during a set time period (e.g., randomly throughout each day).

The speech assessment system may determine whether to generate speech assessment data based on the user profile information and the audio data (406). For example, the speech assessment system may make the determination based on whether or not acoustic parameters determined based on the audio data satisfies an acoustic criterion determined based on the user profile information. If the determination is that the acoustic criterion has not been satisfied (“NO” branch of 406), the speech assessment system may repeat the action (404). However, if the determination is that the acoustic criterion has been satisfied (“YES” branch of 406), the speech assessment system may generate the speech assessment data (408). As another example, the speech assessment system may make the determination based on whether or not a battery level satisfies a battery criterion. For example, the speech assessment system may slow down or stop audio recording if the determination is that the battery criterion has not been satisfied.

Use of audio data alone to generate speech assessment data may be prone to inaccuracy. For instance, it may be difficult to distinguish based on the audio data whether a message was heard by a user but not responded to by the user versus whether the user was not able to perceive the message due to hearing loss, noise, or other factors. The speech assessment system may incorrectly assess the user's speech in these circumstances, which may result in inaccurate evaluation of the speech skills of user 104. Furthermore, continuously using audio data to generate speech assessment data may result in wasteful drain on the resources and may shorten the lifespan of an ear-wearable device.

The techniques of this disclosure may improve the speech assessment efficiency of a speech assessment system. Using user profile information of user 104 and the audio data to generate speech assessment data may provide a more reliable speech measurement than using audio data alone to generate speech assessment data. This is because the speech assessment system may be able to use the user profile information of user 104 to filter out irrelevant audio data. Additionally, examples in which the speech assessment system is implemented on an ear-wearable device, determining whether to generate speech assessment data based on audio data and user profile information may avoid unnecessary expenditure of energy associated with speech assessment data generations. For example, the speech assessment system may be refrained from transmitting audio data wirelessly from ear-wearable device 102A to computing device 300 when the audio data do not meet the acoustic criterion (e.g., the voice of user 104 has not been detected), which may help to lower power consumption for battery 114A of ear-wearable device 102A and power consumption for power source 314 of computing device 300.

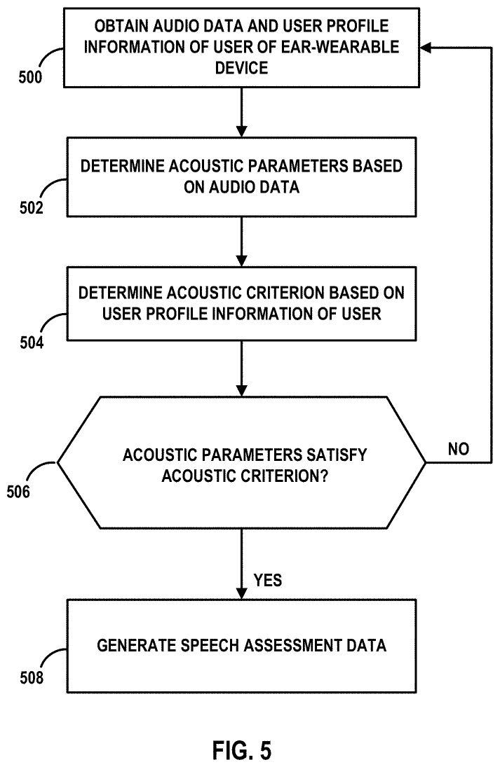

FIG. 5 is a flowchart illustrating an example operation for determining whether to generate speech assessment data based on audio data and user profile information of user 104 of one or more ear-wearable devices 102, in accordance with one or more aspects of this disclosure.

After the speech assessment system (e.g., speech assessment system 218 of FIG. 2 and/or speech assessment system 318 of FIG. 3) obtains audio data and user profile information of user 104 of ear-wearable device(s) 102 (500), the speech assessment system may determine one or more acoustic parameters based on received audio data (502). The one or more acoustic parameters may include noise levels of the audio data, frequency bands of the audio data, and other acoustic parameters associated with the audio data, e.g., acoustic environments of the audio data.

Furthermore, the speech assessment system may determine one or more acoustic criteria based on the user profile information of user 104 (504). For example, the speech assessment system may determine one or more acoustic criteria based on the problem user 104 is experiencing. The one or more acoustic criteria may include a noise threshold, a speech-in-noise test, a frequency range that is audible or inaudible to user 104, and other acoustic criteria determined based on the user profile information of user 104. For example, user 104 may lose sensitivity to certain frequencies of sound due to hearing loss, and the speech assessment system may determine a frequency range that can be heard or cannot be heard by user 104 based on the hearing loss diagnosis of user 104. As another example, the speech assessment system may provide a recommendation to user 104 regarding the acoustic environment (e.g., the speech assessment system may provide a pop-up message that suggests user 104 to turn down the background noise) if the speech assessment system determines that the acoustic environment may have an effect on speech production or understanding of user 104. The speech assessment system may further determine the one or more acoustic criteria based on other data included in the user profile information of user 104, such as the native language of user 104, language that is being learned, education level, hearing status, socio-economic status, health condition, fitness level, speech or language diagnosis, speech or language goal, treatment type, treatment duration of user 104, and other data related to user 104.

The speech assessment system may then determine whether or not the one or more acoustic parameters determined based on the audio data satisfy the one or more acoustic criteria determined based on the user profile information of user 104 (506). The speech assessment system may make this determination in any of various ways. In some examples, the speech assessment system may compare the captured audio data with audio data of a stored user voice sample. For example, the speech assessment system may extract one or more of a fundamental frequency, harmonics, modulation (SNR) estimates, a coherence between the two microphones 210, and other sound features, and compare the extracted sound features with sound features of a stored user voice sample. In response to determining that the voice of user 104 is present, the speech assessment system may generate speech assessment data.

In some examples, one or more acoustic parameters include a noise level, and one or more acoustic criteria include a noise threshold. The speech assessment system may determine that the one or more acoustic parameters satisfy the one or more acoustic criteria based on the noise level meets the noise threshold. The noise threshold may include a static value where a momentary spike is sufficient for the speech assessment system to determine that the one or more acoustic parameters do not satisfy the one or more acoustic criteria. Alternatively, the noise threshold may include an average noise magnitude over a period of time (e.g., over ten seconds).

In some examples, one or more acoustic parameters include a frequency band, and one or more acoustic criteria include a frequency range. The speech assessment system may determine the one or more acoustic parameters satisfy the one or more acoustic criteria based on the frequency band meeting the frequency threshold.

In response to determining that the one or more acoustic parameters determined based on the audio data satisfy the one or more acoustic criteria determined based on the user profile information of user 104 (“YES” branch of 506), the speech assessment system may generate speech assessment data (508). However, if the speech assessment system determines that the one or more acoustic determined based on the audio data has not satisfied the one or more acoustic criteria determined based on the user profile information of user 104 (“NO” branch of 506), the speech assessment system may continue to obtain audio data and determine whether or not to generate speech assessment data.

The generated speech assessment data may be provided to user 104 or a third party (e.g., a family member or a medical professional) in various ways. For example, the speech assessment system may send a message to a computing device (e.g., a smartphone or tablet) capable of communicating with ear-wearable device(s) 102. In some examples, the message is a text message, such as an SMS text message, social media message, or an instant message (e.g., a MESSAGES™ message on a Messages application from Apple Inc. of Cupertino, Calif., Facebook MESSENGER™ message, etc.). For example, a message including the generated speech assessment data may be sent to an educator to indicate the level of the background noise in a classroom throughout a day. In this example, the speech assessment data may include an average noise level throughout the day (e.g., a noise level in decibel), an estimated signal-to-noise ratio (SNR), identified sound classes (e.g., speech, noise, machine noise, music, wind noise, etc.), an estimate of the reverberation in the classroom, and other data. The speech assessment data may further include recommendations for classroom accommodations and modifications, such as recommend the educator to use sound absorption materials (e.g., carpet) in the classroom to reduce background noise.

In some examples, the speech assessment system may provide the generated speech assessment data in an application, such as companion application 324. For example, companion application 324 may display the speech assessment data to user 104. In one example, the speech assessment data may include an average noise level of the audio data and an identified acoustic environment of the audio data. The speech assessment data may further include recommendations for the identified acoustic environment. For example, when the speech assessment system determines ear-wearable device(s) 102 was operated in a room where user 104 was seated next to a heater, the speech assessment system may generate recommendations for controlling noise, such as recommending user 104 choose a sitting location within the room that is away from the heater or having the heater run during times of the day when user 104 is not present. Alternatively, the speech assessment system may recommend that user 104 be seated facing away from the noise so that the directional microphones, if present in ear-wearable device(s) 102, are able to reduce that sound. Finally, if the speech assessment system detects that user 104 is not receiving enough speech input from others, it may recommend user 104 increase or modify the linguistic input that he or she receives (e.g., by recommending user 104 spend more time listening to, or actively speaking with, other people).

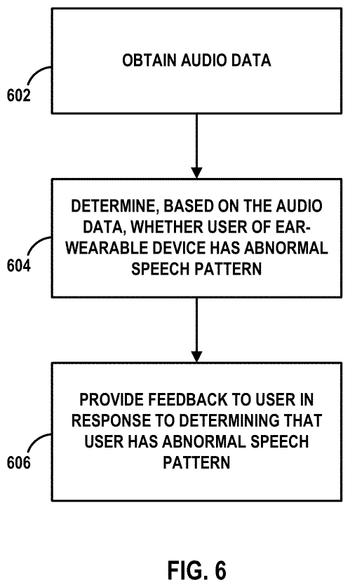

In some examples, the speech assessment system may provide speech assessment data as audible feedback to user 104 of ear-wearable device(s) 102 via receiver 206 of ear-wearable device(s) 102. FIG. 6 is a flowchart illustrating an example operation for generating audible feedback, visual feedback or vibrotactile feedback to user 104 via ear-wearable device 102, in accordance with one or more aspects of this disclosure.

After the speech assessment system (e.g., speech assessment system 218 of FIG. 2 and/or speech assessment system 318 of FIG. 3) obtains audio data (602), the speech assessment system may determine, based on the audio data, whether user 104 of ear-wearable device(s) 102 has an abnormal speech pattern (604). For example, the audio data may include one or more words, phrases or sentences provided by user 104, and the speech assessment system may determine whether user 104 has mispronounced the one or more words.

In some examples, the speech assessment system may extract one or more speech features from the audio data and determine whether user 104 has an abnormal speech pattern based on the one or more extracted speech features. The one or more speech features may represent acoustic properties of user 104 speaking one or more words. For example, one or more extracted speech features may include pitch (e.g., frequency of sound), loudness (e.g., amplitude of sound), syllables, intonation, and other speech features to determine whether user 104 of ear-wearable device(s) 102 has an abnormal speech pattern based on the audio data. For example, user 104 may mispronounce the word “clothes” as “clothe-iz,” and the speech assessment system may extract syllables from the audio data and determine user 104 has an abnormal speech pattern since user 104 mispronounced the word with an extra syllable.

In response to determining user 104 of ear-wearable device(s) 102 has an abnormal speech pattern, the speech assessment system may provide feedback to user 104 via receiver 206 of ear-wearable device(s) 102 (606). In some examples, user 104 may be provided with audible feedback, such as a tone, beep or other sound indicating that the individual has made an error in pronunciation, grammar, etc., or may include the correct pronunciation of the spoken sound, word, or phrase. Alternatively, user 104 could be provided with audible feedback whenever pronouncing challenging sounds, words, or phrases correctly. In this example, the audible feedback may be provided directly from ear-wearable device(s) 102 to user 104 via receiver 206, enabling the audible feedback to be completely hidden from others. In some examples, the audible feedback may help user 104 to improve his or her prosody in speech (e.g., to provide correct patterns of stress and intonation to help user 104 to express himself/herself better). In this example, the audible feedback may help user 104 sound more confident in a conversation or in public speaking.

In some examples, the speech assessment system may provide visual feedback or vibrotactile feedback to user 104 in response to determining user 104 of ear-wearable device(s) 102 has an abnormal (or normal) speech pattern. For example, user 104 could be provided with vibrotactile feedback whenever pronouncing challenging sounds, words, or phrases incorrectly. As another example, user 104 could be provided with phonetic symbols to help user 104 to improve his or her pronunciation.

In some examples, the speech assessment data generated by computing system 108 may include a potential type of abnormal speech patterns determined based on the received audio data and one or more recommendations generated based on the potential type of abnormal speech patterns. FIG. 7A is a chart illustrating example speech and language attributes and types of abnormal speech patterns determined based on the speech and language attributes, in accordance with the techniques of this disclosure.

FIG. 7A shows chart 700A, including a set of speech and language attributes and types of abnormal speech patterns determined based on the speech and language attributes. The speech and language attributes may include voice attributes, such as fundamental frequency, glottal fry, breathiness, prosody, voice level (dB). Additionally, the speech and language attributes may include speech attributes such as mean length of utterance, word per minute, disfluencies percentage (e.g., pauses, repetitions), use of filler words (e.g., um, ah, er, etc.), sound substitutions (e.g., lisping), sound omissions (e.g., “at” instead of “cat”), the accuracy of vowel sounds (e.g., formant relationships), articulation accuracy (e.g., consonant sounds, formant transitions, etc.), etc. The speech and language attributes may include language attributes such as grammar errors, incorrect use of words (e.g., context, word order), grade/age level of speech, etc. The speech and language attributes may include sociability attributes, such as turn taking, number of communication partners, duration of conversations, mediums of conversations (e.g., live, phone), frequency of repeating one's self. The speech and language attributes may include repetition attributes, such as the frequency of requests for repetition (i.e., user 104 asking another person to repeat what the other person just said) when user 104 is in a quiet environment, the frequency of requests for repetition when user 104 is in a noisy environment, and the like. Although chart 700A includes twenty-three specific examples of speech and language attributes, it should be understood that these twenty-three speech and language attributes are merely exemplary, and the speech assessment system described herein may be built to determine types of abnormal speech patterns based more than these twenty-three speech and language attributes. Further, the twelve conditions listed in FIG. 7A (e.g., hearing loss, educational delay, age-related cognitive declines, etc.) are merely exemplary; many other conditions or goals exist (e.g., intoxication, medication use, neurodegenerative diseases, public speaking, and others) for which the speech assessment system could assess speech, language, and vocal patterns. Additionally, the ratings of “abnormal,” “normal,” and “either,” for each of the twelve conditions on each of the 23 attributes in FIG. 7A should be taken as exemplary, meaning someone who is experiencing a given condition is more likely to experience abnormalities on attributes marked as “A” (abnormal) and less likely to experience abnormalities on attributes marked as “N” (normal) and not as rigidly-defined patterns of speech and language abnormalities that a person with a given condition will experience. For example, someone with hearing loss could also experience abnormal glottal fry, and someone with age-related cognitive decline could have normal words per unit of time, etc.

As a first example, a child with hearing loss may experience abnormalities in a mean length of utterance (MLU), use of filler words (e.g., um, ah, er, etc.), sound substitutions (e.g., lisping), sound omissions (e.g., “at” instead of “cat”), the accuracy of vowel sounds (e.g., formant relationships), grade/age level of speech, turn-taking, duration of conversations, mediums of conversations (e.g., live, phone), and the number of times he asks for repetition in quiet and in noise.

As a second example, someone with an educational delay may experience abnormalities in MLU, grammar errors, incorrect use of words (e.g., context, word order), abnormal grade/age level of speech, duration of conversations and abnormal requests for repetition in noise.

As a third example, someone with an age/cognitive related decline may experience abnormalities in MLU, word per minute, disfluencies percentage (e.g., pauses, repetitions), use of filler words (e.g., um, ah, er, etc.), incorrect use of words (e.g., context, word order), number of communication partners, duration of conversations, mediums of conversations (e.g., live, phone), frequency of repeating one's self, repetition asked in a quiet environment, and repetition asked in quiet and noisy environments.

As a fourth example, someone who is a second language learner may experience abnormalities in prosody, MLU, word per minute, disfluencies percentage (e.g., pauses, repetitions), use of filler words (e.g., um, ah, er, etc.), sound substitutions (e.g., lisping), sound omissions (e.g., “at” instead of “cat”), the accuracy of vowel sounds (e.g., formant relationships), articulation accuracy (e.g., consonant sounds, formant transitions, etc.), grammar errors, incorrect use of words (e.g., context, word order), grade/age level of speech, duration of conversations, and requests for repetition in quiet and noise.

As a fifth example, someone with autism may experience abnormalities in prosody, MLU, word per minute, disfluencies percentage (e.g., pauses, repetitions), the accuracy of vowel sounds (e.g., formant relationships), articulation accuracy (e.g., consonant sounds, formant transitions, etc.), grade/age level of speech, turn-taking, number of communication partners, duration of conversations, and frequency of repeating one's self.

As a sixth example, someone with general language delay may experience abnormalities in MLU, word per minute, disfluencies percentage (e.g., pauses, repetitions), use of filler words (e.g., um, ah, er, etc.), grammar errors, incorrect use of words (e.g., context, word order), turn-taking, and duration of conversations.

As a seventh example, someone with stuttering may experience abnormalities in MLU, word per minute, disfluencies percentage (e.g., pauses, repetitions), and use of filler words (e.g., um, ah, er, etc.).

As an eighth example, someone with abnormal articulations may experience abnormalities in sound substitutions (e.g., lisping), sound omissions (e.g., “at” instead of “cat”), the accuracy of vowel sounds (e.g., formant relationships), and articulation accuracy (e.g., consonant sounds, formant transitions, etc.).

As a ninth example, someone with a voice disorder may experience abnormalities in fundamental frequency, glottal fry, breathiness, voice level (dB), sound substitutions (e.g., lisping), sound omissions (e.g., “at” instead of “cat”), the accuracy of vowel sounds (e.g., formant relationships), and articulation accuracy (e.g., consonant sounds, formant transitions, etc.).

As a tenth example, someone with apraxia may experience abnormalities in prosody, MLU, word per minute, disfluencies percentage (e.g., pauses, repetitions), sound substitutions (e.g., lisping), sound omissions (e.g., “at” instead of “cat”), the accuracy of vowel sounds (e.g., formant relationships), articulation accuracy (e.g., consonant sounds, formant transitions, etc.), and grade/age level of speech.

As an eleventh example, someone with dysarthria may experience abnormalities in prosody, voice level (dB), word per minute, disfluencies percentage (e.g., pauses, repetitions), use of filler words (e.g., um, ah, er, etc.), sound substitutions (e.g., lisping), sound omissions (e.g., “at” instead of “cat”), the accuracy of vowel sounds (e.g., formant relationships), articulation accuracy (e.g., consonant sounds, formant transitions, etc.), and grade/age level of speech.

As a twelfth example, someone with aphasia may experience abnormalities in MLU, word per minute, disfluencies percentage (e.g., pauses, repetitions), use of filler words (e.g., um, ah, er, etc.), sound substitutions (e.g., lisping), grammar errors, incorrect use of words (e.g., context, word order), number of communication partners, duration of conversations, mediums of conversations (e.g., live, phone), repetition asked in a quiet environment, and requests for repetition quiet and noisy environments. It should be understood, however, people without abnormal speech patterns may be rated as abnormal in one or more speech and language attributes.

FIG. 7B is a chart illustrating example speech and language attributes and various inputs and algorithms used to assess these speech and language attributes, in accordance with the techniques of this disclosure. FIG. 7B shows chart 700B, including example speech and language attributes and various inputs and algorithms used to assess speech and language attributes. For example, speech assessment system 218 may evaluate the accuracy of the fundamental frequency of user 104 using algorithms 1, 2, 9, and 13. Speech assessment system 218 may compare the fundamental frequency of user 104 to a normative acoustic profile using inputs 6, 7, and 8. In some examples, speech assessment system 218 may evaluate the degree to which the speech of user 104 is breathy using algorithms 1, 2, 9, and 13. Speech assessment system 218 may compare the breathiness of user 104 to a normative acoustic profile using inputs 6, 7, and 8. Speech assessment system 218 may further generate outputs for display using algorithms 11 and 12. Furthermore, algorithms 11 and 12 may aid in the interpretation of the other data. For example, while breathiness of speech may be abnormal under most circumstances, it may be deemed normal if biometric data and/or location services suggest that the person is performing aerobic activity.

In some examples, the various algorithms used to assess speech and language attributes may include a voice identification function configured to detect the voice of user 104. The voice identification function may detect the voice of user 104 based on acoustic analysis and/or through the use of other sensors, such as the use of vibration sensors to detect the vocalizations of user 104. By using the voice identification function, speech assessment system 218 may flag segments of audio as belonging to user 104 or to another person or source.

In some examples, the various algorithms used to assess speech and language attributes may include an acoustic analysis function configured to analyze an audio signal. The acoustic analysis function may take in an audio signal and output an overall decibel level (dB SPL) of the audio signal. In some examples, the acoustic analysis function may include a frequency analysis function configured to determine the frequencies at which there is energy, the relationships between these frequencies to inform whether vowels and consonants are pronounced correctly. In some examples, the acoustic analysis function may further track relationships over time to detect abnormal prosody, estimated signal-to-noise ratios, sound classes (e.g., speech, noise, machine noise, music, wind noise, own voice, etc.), voice quality, etc.

In some examples, the various algorithms used to assess speech and language attributes may further include a speech recognition function configured to convert audio to text, a metalinguistic function configured to analyze captured speech (e.g., analyze speech for sentiment, emotion, number, and identification of talkers, etc.), and a clock function (e.g., used to determine speech rate, frequency, duration of conversations, the number of filler words used during a specified amount of time, etc.).

In some examples, the various algorithms may take captured audio, user profile information (e.g., user profile information 214 and/or user profile information 328, including goals, demographics, diagnosis, hearing loss, etc.), normative speech profile, medium of the conversations (e.g., data indicating whether conversations are in person (acoustic) or through some other medium (e.g., a streamed audio source)), sensors data (e.g., heart rate, body temperature, blood pressure, motion (IMU), gaze direction, etc.), and location data (e.g., GPS data) as inputs to assess speech and language attributes.

In some examples, the various algorithms used to assess speech and language attributes may include a data integration function configured to combine one or more data sets into a combined, unified data set. For example, the data integration function may combine speech profile data of various profiles from various sources into a normative speech profile. As another example, the data integration function may combine one or more results of the speech analysis into a combined, unified result.

In some examples, the various algorithms used to assess speech and language attributes may further include a data display function configured to generate text and/or graphical presentation of the data to user 104 and a data storage function configured to store the generated text and/or graphical presentation of the data.

In some examples, speech assessment system 218 may generate an overall speech score (e.g., a weighted speech score) that summarizes one or more attributes related to vocal quality, speech skills, language skills, sociability, requests for repetition, or overall speech and language skills of user 104. For example, speech assessment system 218 may generate the overall speech score based on assessments of one or more speech scores of user 104. In some examples, speech assessment system 218 may use one or more machine learning (ML) models to generate the overall score. In general, a computing system uses a machine-learning algorithm to build a model based on a set of training data such that the model “learns” how to make predictions, inferences, or decisions to perform a specific task without being explicitly programmed to perform the specific task. For example, speech assessment system 218 may take a plurality of speech and language skill scores provided by a professional or a caregiver to build the machine learning model. Once trained, the computing system applies or executes the trained model to perform the specific task based on new data. In one example, speech assessment system 218 may receive a plurality of speech and language skill scores provided by one or more human raters via a computing device (e.g., computing device 300). Speech assessment system 218 may take the received plurality of speech and language skill scores as inputs to the machine learning model, and generate one or more machine-generated speech and language skill scores. Thus, a plurality of speech and language skill scores may be provided by one or more human raters via a computing device or system, wherein the plurality of speech and language skill scores serve as inputs to the machine learning model and the speech assessment data generated based on the audio data using machine learning model comprises one or more machine-generated speech and language skill scores.

Examples of machine-learning algorithms and/or computer frameworks for machine-learning algorithms used to build the models include a linear-regression algorithm, a logistic-regression algorithm, a decision-tree algorithm, a support vector machine (SVM) algorithm, a k-Nearest-Neighbors (kNN) algorithm, a gradient-boosting algorithm, a random-forest algorithm, or an artificial neural network (ANN), such as a convolutional neural network (CNN) or a deep neural network (DNN). In some examples, a caregiver, healthcare professional or other individual could provide input to the speech assessment system 218, ratings on the individual's speech and language skills. These ratings could be used to improve the accuracy of the assessments of the machine learning algorithm so that over time assessments become more closely match those of human raters.

Although chart 700B includes thirteen specific examples of inputs and algorithms, it should be understood that these thirteen inputs and algorithms are merely exemplary, and the speech assessment system described herein may be built to assess types of abnormal speech patterns using more or fewer than thirteen inputs and algorithms.

As an example, user 104 may experience stuttering and may have an abnormal use of filler words (e.g., um, ah, er, etc.). To assess stuttering severity in user 104, speech assessment system 218 may use a voice identification function to detect the voice of user 104 from a recording, an acoustic analysis function to analyze the recording, a speech recognition function to convert the recording to text, and a metalinguistic function to analysis the recognized speech. Speech assessment system 218 may further use a data display function to generate text and/or graphical presentation of the analysis result to user 104 and use a data storage function to store the generated text and/or graphical presentation of the analysis result.

In some examples, speech assessment system 218 may assess the stuttering severity in user 104 by comparing the performance of user 104 with nonstuttering peers' performances. Speech assessment system 218 may obtain various user profile information of peers with similar backgrounds as user 104 and without stuttering based on user profile information of user 104. Speech assessment system 218 may use a data integration function to combine the various user profile information of peers to generate a normative speech profile. Speech assessment system 218 may further use a clock function to determine the number of filler words user 104 used during a specified amount of time and compare the number of filler words user 104 used with the number of filler words of the normative speech profile. In some examples, a peer group may include other individuals with a similar stuttering problem. In this case, the peer group may be used to compare performance over time, for example to determine whether an individual is experiencing more or less progress than those who are undergoing similar or different treatment options.

In some examples, speech assessment system 218 may assess the stuttering severity of user 104 using various data, such as a medium of the conversations, sensors data, location data, etc. For example, based on the medium of the conversations, speech assessment system 218 may determine whether user 104 stutters more in face-to-face interactions or over the phone. As another example, based on sensor data and location data, speech assessment system 218 may determine whether stuttering is stress-related (e.g., sensors data indicating user 104 with an elevated heart rate or skin conductance) or whether stutter is location-related (e.g., location data indicating user 104 is at school or at work.).

FIG. 7C is a flowchart illustrating an example operation for determining a potential type of abnormal speech patterns based on the received audio data and generating one or more recommendations based on the potential type of abnormal speech patterns, in accordance with one or more aspects of this disclosure.

The speech assessment system (e.g., speech assessment system 218 of FIG. 2 and/or speech assessment system 318 of FIG. 3) obtains audio data and user profile information of user 104 (702) from ear-wearable device(s) 102 and/or the computing device 300, and may determine whether user 104 of ear-wearable device(s) 102 has abnormal speech patterns based on the audio data and the user profile information of user 104 (704).

User 104 may represent a person who is undergoing treatment for voice disorders (e.g., glottal fry, breathiness), speech disorders (e.g., stuttering, sound omissions or substitutions), or language disorders (e.g., grammar errors, incorrect use of words), or who want to improve his or her pronunciation of certain sounds (e.g., to reduce lisping or to reduce an accent for a non-native speaker of a language).

The speech assessment system may extract speech features from the audio data to track the speech patterns of user 104 using techniques described previously in this disclosure. Additionally, the speech assessment system may analyze the audio data to monitor the vocal quality of user 104, the speech sounds of user 104, the speech skills of user 104, the language skills of user 104, etc. The speech assessment system may determine whether user 104 of ear-wearable device(s) 102 has abnormal speech patterns based on the audio data and the user profile information of the user. For example, by analyzing the audio data, the speech assessment system may detect user 104 was frequently repeating himself and using filler words (e.g., “um,” “ah,” or “er”) in a speech. This indicates user 104 of ear-wearable device(s) 102 may experience abnormal speech patterns.

In response to determining user 104 of ear-wearable device(s) 102 has abnormal speech patterns, the speech assessment system may identify a potential type of abnormal speech patterns in user 104 (706). For example, in response to detecting user 104 was frequently repeating himself and using filler words, the speech assessment system may suggest user 104 is experiencing abnormal cognitive decline. Examples of abnormal speech, language and voice patterns include delay in the development of speech and language skills, vocal tics, stuttering, lisping, glottal fry, incorrect use of words or incorrect word order, or other types of abnormal speech patterns, some of which are listed in 700A. The speech assessment system may then generate one or more recommendations based on the identified potential type of abnormal speech patterns (708).

In some examples, the speech assessment data may be sent to user 104 to suggest user 104 seek a professional for additional speech assessment and/or suggest treatment options for the identified potential type of abnormal speech, language, or vocal patterns. In one example, the speech assessment data may include a list of local healthcare providers. In this example, the list of local healthcare providers may be generated based on the identified potential type of abnormal speech, language or vocal patterns and user profile information of user 104, using location information and/or internet services. In another example, the speech assessment data may include a message to encourage user 104 to engage in certain behaviors targeting improving the identified potential type of abnormal speech patterns. For example, in response to determining that user 104 may experience vocal tics, the speech assessment system may provide habit reversal training strategies for vocal tics to encourage user 104 to control the tics.

The speech assessment data may also be provided to one or more third-parties to inform the third-parties of signs of abnormal speech patterns. In some examples, the speech assessment data may be directed to a family member to indicate medical intervention may be needed. For example, the speech assessment data may indicate whether user 104 has an abnormal speech pattern and whether ear-wearable device(s) 102 need to be adjusted to better serve the user. In some examples, the speech assessment data may be directed at one or more healthcare professionals or educators. For example, the speech assessment data may include potential risks of one or more of a speech-language pathology, delayed language development, vocal tics or other vocal abnormalities, stuttering, lisping, glottal fry, apraxia, dysarthria, aphasia, autism, educational delay, abnormal cognitive decline, and/or other factors associated with user 104 to indicate a preliminary diagnosis.

Various algorithms and/or services may be used to extract one or more speech features from the audio data. For example, the speech assessment system may perform speech recognition (e.g., convert speech to text), natural language processing (e.g., identify entities, key phrases, language sentiment, syntax, topics, etc.), speaker diarization (e.g., determine speaker changes and the number of voices detected, and/or perform emotion detection. FIG. 7D is an overview diagram illustrating an example operation for using various algorithms to analyze the audio data, in accordance with one or more aspects of this disclosure.

As shown in FIG. 7D, the speech assessment system may analyze the audio data to assess the vocal quality of user 104. In particular, the speech assessment system may assess the vocal quality of user 104 based on one or more of a fundamental frequency of user 104, the presence or absence of abnormal speech qualities (e.g., such as the presence or absence of breathiness, gaspiness, glottal fry, etc.), prosody (e.g., tone, such as attitude or emotional status), intonation (e.g., the rise and fall of the voice in speaking, stress, rhythm, etc.), overall speech level, speech rate, and the ability to be understood by others (e.g., speech clarity, which is an aspect of speech intelligibility, and can be assessed by examining one's articulation, speech rate and loudness, etc.).

In some examples, the speech assessment system may analyze the audio data to assess the speech sounds of user 104. In some examples, the speech assessment system may assess the speech sounds of user 104 based on the voicing, place, and manner of articulation for phonemes (e.g., an indivisible unit of sound), morphemes (e.g., the smallest unit within a word that can carry meaning), single words, or connected speech. In some examples, the speech assessment system may further assess the speech sounds of user 104 based on formants (e.g., spectral shaping that results from a resonance in a human vocal tract). The speech assessment system may use formats to determine the quality of vowel sounds, and formant transitions may be used to determine whether the place and manner of the articulation of user 104 are accurate.

In some examples, the speech assessment system may analyze the audio data to assess the speech skills of user 104. In some examples, the speech assessment system may assess the speech skills of user 104 based on the fluency of the speech (e.g., the ability of user 104 to speak a language easily and accurately), the average number of syllables user 104 typically uses in a word, and the average number of words user 104 uses in an utterance (also known as the MLU). In particular, the fluency of the speech may be assessed based on the speech rate of user 104, the presence or absence of stuttering, how frequently user 104 repeats him/herself, the extent to which user 104 uses filler words (e.g., “um,” “ah,” or “er”) or pauses, the extent to which user 104 experiences word-finding difficulties and the accuracy of the articulation of user 104.

In some examples, the speech assessment system may analyze the audio data to assess the language skills of user 104. For example, the speech assessment system may assess the language skills of user 104 based on the adherence of user 104 to standards for grammar, such as phonology (e.g., whether user 104 combines the sounds of speech together correctly for that language), syntax (e.g., whether user 104 puts his/her words in the proper order for that language), semantics (e.g., whether user 104 uses a particular word or phrase correctly within an utterance), and other appropriate measurements (e.g., whether user 104 typically uses of “proper” language versus uses of vernacular or slang, and whether user 104 “code switches” (e.g., whether user 104 changes his/her speech) depending on the communication partners of user 104). In some examples, the speech assessment system may assess the language skills of user 104 based on the vocabulary of user 104, such as the number of words that user 104 understands without asking for clarification and the number of words that user 104 uses when speaking. In other examples, the speech assessment system may further assess the language skills of user 104 based on the ability of user 104 to use context to understand or assess a situation, ability to “fill in the gaps” when information is missing, ability to speculate on future events, ability to understand puns or other jokes, ability to understand similes, metaphors, colloquialisms, idioms, etc. The speech assessment system may assess the abilities of user 104 by examining whether user 104 typically asks for clarification when these linguistic scenarios occur and/or the frequency with which user 104 makes inappropriate responses.

In some examples, the speech assessment system may analyze the audio data to assess other measurements related to the speech and language skills of user 104. For example, the speech assessment system may assess the frequency with which user 104 asks for repetition, the frequency of conversational interactions with others, the duration of the conversational interactions with others, the number of conversational partners that user 104 typically has over some duration of time (e.g., a day or week), the medium through which the conversational interactions of user 104 occur (e.g., in person, over the phone, or via facetime/conference calls, etc.). For example, the speech assessment system may analyze the audio data to determine whether the audio data have been processed through low-pass filters. Signals through telephones are often low-pass filtered, and signals from media sources (e.g., radio signals and audio files) are often highly compressed. For instance, in response to determining the audio data have been processed through low-pass filters, the speech assessment system may determine that the conversational interactions that have occurred over phone. In other examples, the ear-worn device may have internal settings that indicate whether the input signal is acoustic, from a telecoil, streamed from an external device, etc.

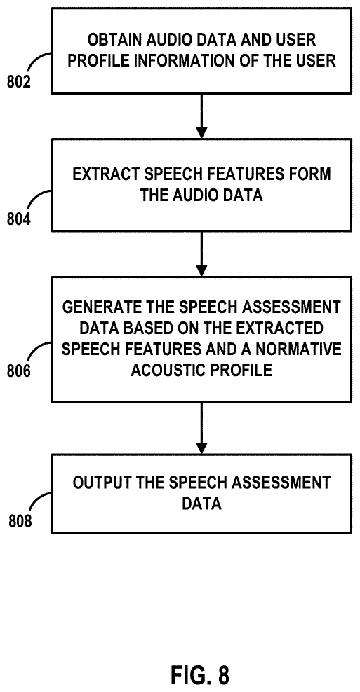

Furthermore, the speech assessment system may compare the speech and language skills of user 104 with his or her peers and generate the speech assessment data based on the comparison. In some examples, a normative speech profile may be used to generate the speech assessment data. FIG. 8 is a flowchart illustrating an example operation for generating speech assessment data based on a normative speech profile, in accordance with one or more aspects of this disclosure. The normative speech profile may also be referred to as a normative acoustic profile.

The speech assessment system (e.g., speech assessment system 218 of FIG. 2 and/or speech assessment system 318 of FIG. 3) obtains audio data, and user profile information of user 104 (802) from ear-wearable device(s) 102 and/or the computing device 300 and may extract speech features from the audio data (804) using techniques described elsewhere in this disclosure. The speech assessment system may further generate speech assessment data based on the extracted speech features and a normative speech profile (806). The normative speech profile may be stored in storage device 202 of ear-wearable device(s) 102 (FIG. 2) or storage device(s) 316 of computing device 300 (FIG. 3). In some examples, a normative speech profile may be a speech profile that is known to be representative of peers with similar backgrounds as user 104 and without speech and language disorder. Peers with similar backgrounds as user 104 may be defined using a variety of criteria and may include any combination of the following: age, gender, geographic location, place of origin, native language, the language that is being learned, education level, hearing status, socio-economic status, health conditions, fitness level, or other demographic or relevant information. In some examples, a normative speech profile may be a speech profile that is known to be representative of, or associated with, a specific speech disorder. For example, a normative speech profile can be compiled from normalizing or averaging user profile information of multiple users with a common speech disorder. In other examples, a normative speech profile may be a speech profile that is known to be representative of others who are undergoing similar treatments as user 104. In other examples, a normative speech profile may be a speech profile that is known to be representative of others who are undergoing different treatments as user 104.

The speech assessment system may compare the extracted speech features of the audio data with normative data from the selected normative speech profile to generate speech assessment data. For example, the speech assessment system may compare the number of syllables user 104 typically uses in a word, the average number of words user 104 uses in a sentence, the overall number of words that user 104 understands, and other speech features extracted from the audio data with normative data from the selected normative speech profile. The groups of normative data that are selected for comparison may be selected automatically (e.g., an application may automatically select the groups of normative data based on user profile information of user 104), by user 104, or by a third party (e.g., a caregiver or a family member may select the groups of normative data based on personal information or goals of user 104), or by trained personnel such as a speech-language pathologist (SLP) or a medical doctor (e.g., an SLP may select the groups of normative data based on a diagnosis of user 104). By comparing the extracted speech features of the audio data with normative data, the speech assessment system may generate speech assessment data indicating whether speech patterns of user 104 is developing (or declining) at the same rate as peers with or without abnormal speech patterns.

In some examples, the speech assessment system may output the speech assessment data (808) via a display, such as output device(s) 310 of FIG. 3. The speech assessment data may include alternative treatment suggestions if user 104 has delays in speech and language development or if user 104 is experiencing declines in speech and language skills. The speech assessment data may also include a message to recommend treatment be stopped or go into a maintenance phase if user 104 does not have a delay in speech and language development (or does not have a decline in speech and language skills).

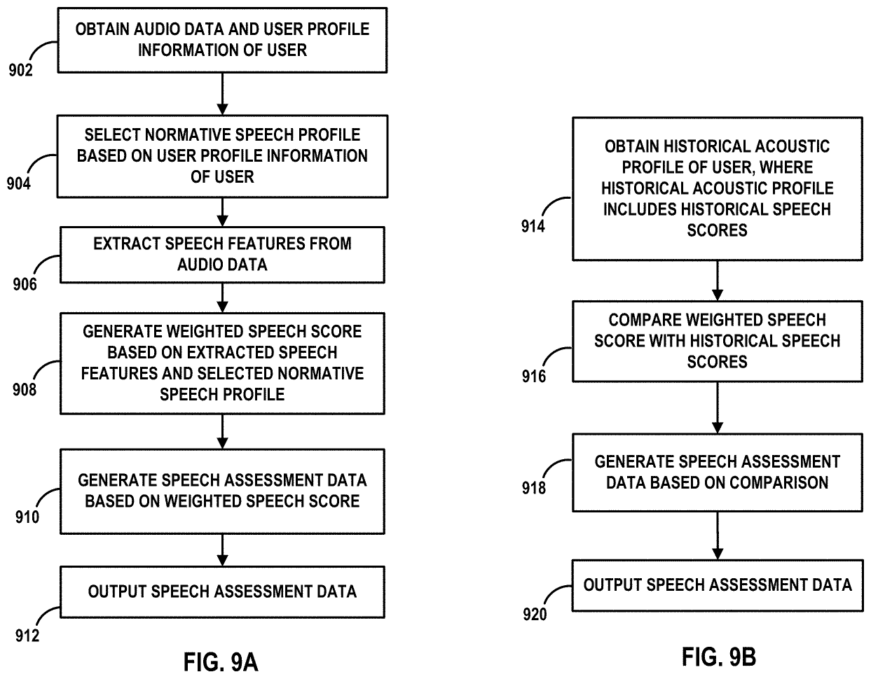

In some examples, speech assessment data generated by the speech assessment system may further include one or more speech scores indicating different speech and language attributes (e.g., voice attributes, language attributes, sociability attributes, repetition attributes, etc.) of the speech and language skills of user 104 of ear-wearable device 102. In some examples, the speech assessment system may generate scores for attributes that are likely to be abnormal for user 104. For example, user 104 may experience stuttering and likely to be abnormal in mean length utterance, word per minute, disfluencies percentage (e.g., pauses, repetitions), and use of filler words (e.g., um, ah, er, etc.). The speech assessment system may be configured to generate a score for each attribute of the mean length of utterance, word per minute, disfluencies percentage, and use of filler words attributes. In some examples, the speech assessment system may generate a composite score for attributes in an attribute category. For example, the speech assessment system may generate a score for each category of the voice attributes, language attributes, sociability attributes, repetition attributes categories. FIG. 9A is a flowchart illustrating an example operation for generating a speech score, in accordance with one or more aspects of this disclosure.

After the speech assessment system (e.g., speech assessment system 218 of FIG. 2 and/or speech assessment system 318 of FIG. 3) obtains audio data and user profile information of user 104 (902), the speech assessment system may select a normative speech profile from a plurality of normative speech profiles based on the user profile information of user 104 (904). The speech assessment system may select the normative speech profile based on the user profile information of user 104 matches at least a portion of the selected normative speech profile. For instance, the selection process may be based on weighted criteria specific to the individual's user profile. The selection process may place higher weight on variables known to contribute more highly to an individual's speech and language skills and less weight to those known to be less important. For example, for a toddler with hearing loss, his or her age, degree of hearing loss, and age at which treatment began will likely contribute more to his/her speech and language development than the specific dialect that he/she speaks of a language. For other individuals (e.g., elderly adults), other profile information (e.g., degree of cognitive decline) may be more important to the selection of an appropriate normative speech profile.

The speech assessment system may further extract speech features from the audio data (906) and generate a speech score for user 104 based on the extracted speech features and the selected normative speech profile (908). The speech assessment system may use various technologies to generate the speech score, such as applying a reading level to generate the speech score. Various algorithms may be used to generate the reading level, such as Flesch Reading Ease Formula, Flesch-Kincaid Grade Level, Fog Scale, Simple Measure of Gobbledygook (SMOG) Index, Automated Readability Index, Coleman-Liau Index, Linsear Write Formula, and Dale-Chall Readability Score. The speech assessment system may then generate speech assessment data base on the speech score (910) and output the speech assessment data (912) to user 104 and/or one or more third parties.

In some examples, the one or more speech scores provided by the speech assessment system may be used to encourage user 104 of ear-wearable device(s) 102 to engage in activities associated with speech and language development. For example, speech assessment data generated by the speech assessment system may include the speech scores and target speech scores determined based on the selected normative speech profile. The speech assessment data may further provide a benchmark for a set of goals. For example, the speech assessment system may compare a speech score with a target score to determine user 104 is at 75% of the goal for the week. The speech assessment system may further provide, based on a determination that the speech score has not satisfied the target speech score, a message that prompts user 104 to engage in activities or games for speech therapy.

In some examples, one or more speech scores may be used to determine whether the user's speech, language and vocal skills are developing (or declining) over a period of time. FIG. 9B is a flowchart illustrating an example operation for comparing a speech score with a historical speech score, in accordance with one or more aspects of this disclosure.

The speech assessment system (e.g., speech assessment system 218 of FIG. 2 and/or speech assessment system 318 of FIG. 3) may obtain a historical speech profile of user 104 (914) of ear-wearable device(s) 102. For example, a request for the historical speech profile of user 104 may be sent from speech assessment system 318 of computing device 300 to ear-wearable device(s) 102. In response to the request, ear-wearable device(s) 102 may verify the identity of computing device 300 and send historical speech profile of user 104 after verification. The historical speech profile of user 104 includes historical data related to user 104, such as one or more historical speech scores generated over a period of time. The speech assessment system may further compare the speech score with the one or more historical speech scores (916) and generate speech assessment data based on the comparison (918). By comparing the speech score with the one or more historical speech scores, the speech assessment system may provide an overall tendency of the speech score of user 104 over a period of time. In some examples, some or all of the speech profile may exist on computing device 300.

The speech assessment system may output the speech assessment data to user 104 and/or one or more third parties. In some examples, a companion computing device, such as computing device 300 of FIG. 3, may provide a GUI that presents graphics (e.g., charts, tables, diagrams, etc.) that indicate the user's achieved speech score, e.g., as compared to past achievement. In some examples, the speech assessment system may output the speech assessment data to computing device 300, which will then output the data to one or more third parties.

The following is a non-exclusive list of aspects that are in accordance with one or more techniques of this disclosure.

Aspect 1: A method includes storing user profile information of a user of an ear-wearable device, wherein the user profile information comprises parameters that control operation of the ear-wearable device; obtaining audio data from one or more sensors that are included in the ear-wearable device; determining whether to generate speech assessment data based on the user profile information of the user and the audio data, wherein the speech assessment data provides information regarding speech of the user; and generating the speech assessment data based on the determination to generate speech assessment data.

Aspect 2: The method of aspect 1, further comprises: determining whether to generate a snapshot based on the user profile information of the user; and generate the snapshot based on the determination to generate the snapshot.

Aspect 3: The method of aspects 1 or 2, wherein determining whether to generate the speech assessment data based on the user profile information of the user and the audio data further comprises: determining whether to generate speech assessment data based on sensor data or location data.

Aspect 4: The method of any of aspects 1 to 3, wherein determining whether to generate speech assessment data based on the user profile information of the user and the audio data comprises: determining one or more acoustic parameters based on the audio data; determining an acoustic criterion based on the user profile information of the user; comparing the one or more acoustic parameters to the acoustic criterion; and determining to generate the speech assessment data in response to determining the one or more acoustic parameters satisfy the acoustic criterion.

Aspect 5: The method of aspect 4, wherein the one or more acoustic parameters comprise one or more of: a frequency band, a frequency range, a frequency response, a frequency relationship, a frequency pattern, a sound class, a sound level, an estimated signal-to-noise ratio (SNR), a compression ratio, an estimated reverberation time, a fundamental frequency of voice of the user, a formant relationship or formant transition of the voice of the user, and a duration of sound.

Aspect 6: The method of any of aspects 1 to 5, wherein generating the speech assessment data comprises: determining whether the user has an abnormal speech pattern based on the audio data; and in response to determining the user has abnormal speech pattern, providing audible feedback, visual feedback, or vibrotactile feedback to the user.

Aspect 7: The method of any of aspects 1 to 6, wherein generating the speech assessment data comprises: determining whether the user has an abnormal speech patterns based on the audio data and the user profile information of the user; in response to determining the user has abnormal speech patterns, determining a potential type of abnormal speech patterns based on the audio data; and generating a recommendation based on the potential type of abnormal speech patterns.

Aspect 8: The method of aspect 7, wherein the type of abnormal speech patterns are determined based on speech and language attributes, wherein the speech and language attributes include voice attributes, speech quality attributes, language attributes, sociability attributes, or repetition attributes.

Aspect 9: The method of aspect 8, wherein the voice attributes include at least one of: frequency, amount of glottal fry, breathiness measurement, prosody measurement, or voice level (dB).

Aspect 10: The method of aspect 8 or 9, wherein the speech quality attributes include at least one of: mean length utterance (MLU), words per unit of time, amount of disfluencies, amount of filler words, amount of sound substitutions, amount of sound omissions, accuracy of vowel sounds, or articulation accuracy.

Aspect 11: The method of any of aspects 8 to 10, wherein the language attributes include at least one of: amount of grammar errors, amount of incorrect use of words, grade level of speech, or age level of speech.

Aspect 12: The method of any of aspects 8 to 11, wherein the sociability attributes include at least one of: amount of turn-taking, number of communication partners, duration of conversations, mediums of conversations, or repetition frequency.

Aspect 13: The method of any of aspects 8 to 12, wherein repetition attributes include amount of repetition asked in a quiet environment, or amount of repetition asked in a noisy environment.

Aspect 14: The method of any of aspects 1 to 13, wherein generating the speech assessment data comprises: receiving a plurality of speech and language skill scores from a computing device; generating a machine learning model based on the plurality of speech and language skill scores; and generating the speech assessment data based on the audio data using the machine learning model.

Aspect 15: The method of aspect 14, wherein the plurality of speech and language skill scores are provided by one or more human raters via the computing device, wherein the plurality of speech and language skill scores serve as inputs to the machine learning model, wherein the speech assessment data generated based on the audio data using machine learning model comprises one or more machine-generated speech and language skill scores.

Aspect 16: The method of any of aspects 1 to 15, wherein generating the speech assessment data comprises: extracting speech features from the audio data; generating the speech assessment data at least based on the extracted speech features and a normative speech profile; and outputting the speech assessment data.

Aspect 17: The method of aspect 16, wherein generating the speech assessment data at least based on the extracted speech features and the normative speech profile comprises: selecting the normative speech profile from a plurality of normative speech profiles, wherein at least a portion of the normative speech profile matches the user profile information of the user; generating one or more speech scores based on the extracted speech features and the selected normative speech profile; and generating the speech assessment data based on the speech score.

Aspect 18: The method of aspect 17, wherein generating the one or more speech scores comprises using at least one of: Flesch Reading Ease Formula, Flesch-Kincaid Grade Level, Fog Scale, SMOG Index, Automated Readability Index, Coleman-Liau Index, Linsear Write Formula, and Dale-Chall Readability Score.

Aspect 19: The method of aspects 17 or 18, wherein generating the one or more speech scores comprises generating a weighted speech score, wherein the weighted speech score summarizes one or more attributes related to vocal quality, speech skills, language skills, sociability, requests for repetition, or overall speech and language skills of the user.

Aspect 20: The method of any of aspects 17 to 19, wherein generating the speech assessment data further comprises generating the speech assessment data based on a historical speech profile of the user, wherein the historical speech profile of the user includes one or more historical speech scores.

Aspect 21: The method of aspect 20, wherein generating the speech assessment data based on the historical speech profile of the user comprises: comparing the one or more speech scores with the one or more historical speech scores; and generating the speech assessment data based on the comparison.

Aspect 22: The method of any of aspects 1 to 21, wherein the user profile information of the user further comprises at least one of: demographic information, an acoustic profile of own voice of the user, data indicating presence, status or settings of one or more pieces of hardware on the ear-wearable device, data indicating when a snapshot or the speech assessment data should be generated, data indicating which analyses should be performed on the audio data, data indicating which results should be displayed or sent to a companion computing device.

Aspect 23: The method of aspect 22, wherein the demographic information comprises one or more of: age, gender, geographic location, place of origin, native language, language that is being learned, education level, hearing status, socio-economic status, health condition, fitness level, speech or language diagnosis, speech or language goal, treatment type, or treatment duration of the user.

Aspect 24: The method of aspects 22 or 23, wherein the acoustic profile of own voice of the user comprises one or more of: the fundamental frequency of the user or one or more frequency relationships of sounds spoken by the user, wherein the one or more frequency relationships comprises formants and formant transitions.

Aspect 25: The method of any of aspects 22 to 24, wherein the settings of the one or more pieces of hardware on the ear-wearable device comprise one or more of: a setting of the one or more sensors, a setting of microphones, a setting of receivers, a setting of telecoils, a setting of wireless transmitters, a setting of wireless receivers, or a setting of batteries of the ear-wearable device.

Aspect 26: The method of any of aspects 22 to 25, wherein the data indicating when the snapshot or the speech assessment data should be generated comprises one or more of: a specified time or a time interval, whether a sound class or an acoustic characteristic is identified, whether a specific activity is detected, whether a certain communication medium is detected, whether a certain biometric threshold has been passed, whether a specific geographic location is entered.

Aspect 27: The method of any of aspects 22 to 26, wherein the snapshot comprises one or more of: unprocessed data from the ear-wearable device or analyses that have been performed by the ear-wearable device.

Aspect 28: The method of aspect 27, wherein the analyses that have been performed by the ear-wearable device comprises one or more of: summaries of the one or more acoustic parameters, summaries of amplification settings, summaries of features and algorithms that are active in the ear-wearable device, summaries of sensor data, or summaries of the hardware settings of the ear-wearable device.

Aspect 29: The method of any of aspect 22 to 28, further includes receiving an instruction provided by the user or a third party; and generating the speech assessment data based on the instruction, wherein the instruction comprises one or more of: an on instruction configured to turn on the analyses; an off instruction configured to turn off the analyses; and an edit instruction configured to edit the analyses.

Aspect 30: A computing system includes a data storage system configured to store data related to an ear-wearable device; and one or more processing circuits configured to: store user profile information of a user of the ear-wearable device, wherein the user profile information comprises parameters that control operation of the ear-wearable device; obtain audio data from one or more sensors that are included in the ear-wearable device; determine whether to generate speech assessment data based on the user profile information of the user and the audio data, wherein the speech assessment data provides information regarding speech of the user; and generate the speech assessment data based on the determination.

Aspect 31: The computing system of aspect 30, wherein the one or more processors are configured to perform the methods of any of aspects 2 to 29.

Aspect 32: An ear-wearable device includes one or more processors configured to: store user profile information of a user of the ear-wearable device, wherein the user profile information comprises parameters that control operation of the ear-wearable device; obtain audio data from one or more sensors that are included in the ear-wearable device; determine whether to generate speech assessment data based on the user profile information of the user and the audio data, wherein the speech assessment data provides information regarding speech of the user; and generate the speech assessment data based on the determination.

Aspect 33: The ear-wearable device of aspect 32, wherein the ear-wearable device comprises a cochlear implant.

Aspect 34: The ear-wearable device of aspect 32, wherein the one or more processors are configured to perform the methods of any of aspects 2 to 29.

Aspect 35: A computer-readable data storage medium having instructions stored thereon that, when executed, cause one or more processing circuits to: store user profile information of a user of the ear-wearable device, wherein the user profile information comprises parameters that control operation of the ear-wearable device; obtain audio data from one or more sensors that are included in the ear-wearable device; determine whether to generate speech assessment data based on the user profile information of the user and the audio data, wherein the speech assessment data provides information regarding speech of the user; and generate the speech assessment data based on the determination.

Aspect 36: The computer-readable data storage medium of aspect 34, wherein the instructions further cause the one or more circuits to perform the methods of any of aspects 2-29.

In this disclosure, ordinal terms such as “first,” “second,” “third,” and so on, are not necessarily indicators of positions within an order, but rather may be used to distinguish different instances of the same thing. Examples provided in this disclosure may be used together, separately, or in various combinations.

In this disclosure, the term “speech,” or “speech and language,” should be taken to broadly mean any aspect of one's speech or language, including one's voice, grammar, sociability, requests for repetition, any of the 23 attributes listed in FIG. 7A, any of the attributes or concepts listed in this document or generally associated with one's speech, language, voice or other communication skills.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates the transfer of a computer program from one place to another, e.g., according to a communication protocol. In this manner, computer-readable media generally may correspond to (1) tangible computer-readable storage media, which is non-transitory, or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, cache memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk, and Blu-ray disc, where disks usually reproduce data magnetically, while discs reproduce data optically with lasers. Combinations of the above should also be included within the scope of computer-readable media.

The functionality described in this disclosure may be performed by fixed-function and/or programmable processing circuitry. For instance, instructions may be executed by fixed-function and/or programmable processing circuitry. Such processing circuitry may include one or more processors, such as one or more digital signal processors (DSPs), general-purpose microprocessors, application-specific integrated circuits (ASICs), field programmable logic arrays (FPGAs), or other equivalent integrated or discrete logic circuitry. Accordingly, the term “processor,” as used herein, may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chipset). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
storing user profile information of a user of an ear-wearable device, wherein the user profile information comprises parameters that control operation of the ear-wearable device;
obtaining audio data from one or more sensors that are included in the ear-wearable device;
determining whether to generate speech assessment data based on the user profile information of the user and the audio data, wherein the speech assessment data provides information regarding speech of the user; and
generating the speech assessment data based on the determination to generate the speech assessment data.

2. The method of claim 1, wherein determining whether to generate the speech assessment data based on the user profile information of the user and the audio data further comprises:
determining whether to generate speech assessment data based on sensor data or location data.

3. The method of claim 1, wherein determining whether to generate the speech assessment data based on the user profile information of the user and the audio data comprises:
determining one or more acoustic parameters based on the audio data;
determining an acoustic criterion based on the user profile information of the user;
comparing the one or more acoustic parameters to the acoustic criterion; and
determining to generate the speech assessment data in response to determining the one or more acoustic parameters satisfy the acoustic criterion.

4. The method of claim 1, wherein generating the speech assessment data comprises:
determining whether the user has an abnormal speech pattern based on the audio data; and
in response to determining the user has the abnormal speech pattern, providing audible feedback, visual feedback, or vibrotactile feedback to the user.

5. The method of claim 1, wherein generating the speech assessment data comprises:
determining whether the user has abnormal speech patterns based on the audio data and the user profile information of the user;
in response to determining the user has the abnormal speech patterns, determining a potential type of abnormal speech patterns based on the audio data; and
generating a recommendation based on the potential type of abnormal speech patterns.

6. The method of claim 5, wherein the type of abnormal speech patterns is determined based on speech and language attributes, wherein the speech and language attributes include voice attributes, speech quality attributes, language attributes, sociability attributes, or repetition attributes.

7. The method of claim 6,
wherein the voice attributes include at least one of: frequency, amount of glottal fry, breathiness measurement, prosody measurement, or voice level (dB),
wherein the speech quality attributes include at least one of: mean length utterance (MLU), words per unit of time, amount of disfluencies, amount of filler words, amount of sound substitutions, amount of sound omissions, accuracy of vowel sounds, or articulation accuracy,
wherein the language attributes include at least one of: amount of grammar errors, amount of incorrect use of words, grade level of speech, or age level of speech,
wherein the sociability attributes include at least one of: amount of turn-taking, number of communication partners, duration of conversations, mediums of conversations, or repetition frequency, and
wherein repetition attributes include amount of repetition asked in a quiet environment, or amount of repetition asked in a noisy environment.

8. The method of claim 1, wherein generating the speech assessment data comprises:
receiving a plurality of speech and language skill scores from a computing device;
generating a machine learning model based on the plurality of speech and language skill scores; and
generating the speech assessment data based on the audio data using the machine learning model.

9. The method of claim 8, wherein the plurality of speech and language skill scores are provided by one or more human raters via the computing device, wherein the plurality of speech and language skill scores serve as inputs to the machine learning model, wherein the speech assessment data generated based on the audio data using the machine learning model comprises one or more machine-generated speech and language skill scores.

10. The method of claim 1, wherein generating the speech assessment data comprises:
extracting speech features from the audio data;
generating the speech assessment data at least based on the extracted speech features and a normative speech profile; and
outputting the speech assessment data.

11. The method of claim 10, wherein generating the speech assessment data at least based on the extracted speech features and the normative speech profile comprises:
selecting the normative speech profile from a plurality of normative speech profiles, wherein at least a portion of the normative speech profile matches the user profile information of the user;
generating one or more speech scores based on the extracted speech features and the selected normative speech profile; and
generating the speech assessment data based on the speech score.

12. The method of claim 1, wherein the user profile information of the user further comprises at least one of: demographic information, an acoustic profile of own voice of the user, data indicating presence, status or settings of one or more pieces of hardware on the ear-wearable device, data indicating when a snapshot or the speech assessment data should be generated, data indicating which analyses should be performed on the audio data, data indicating which results should be displayed or sent to a companion computing device.

13. The method of claim 12,
wherein the demographic information comprises one or more of: age, gender, geographic location, place of origin, native language, language that is being learned, education level, hearing status, socio-economic status, health condition, fitness level, speech or language diagnosis, speech or language goal, treatment type, or treatment duration of the user,
wherein the acoustic profile of own voice of the user comprises one or more of: the fundamental frequency of the user or one or more frequency relationships of sounds spoken by the user, wherein the one or more frequency relationships comprises formants and formant transitions,
wherein the settings of the one or more pieces of hardware on the ear-wearable device comprise one or more of: a setting of the one or more sensors, a setting of microphones, a setting of receivers, a setting of telecoils, a setting of wireless transmitters, a setting of wireless receivers, or a setting of batteries of the ear-wearable device, and
wherein the data indicating when the snapshot or the speech assessment data should be generated comprises one or more of: a specified time or a time interval, whether a sound class or an acoustic characteristic is identified, whether a specific activity is detected, whether a certain communication medium is detected, whether a certain biometric threshold has been passed, whether a specific geographic location is entered.

14. The method of claim 12, further comprising:
receiving an instruction provided by the user or a third party; and
generating the speech assessment data based on the instruction, wherein the instruction comprises one or more of:
an on instruction configured to turn on the analyses;
an off instruction configured to turn off the analyses; and
an edit instruction configured to edit the analyses.

15. A computing system comprising:
a data storage system configured to store data related to an ear-wearable device; and
one or more processing circuits configured to:
store user profile information of a user of the ear-wearable device,
wherein the user profile information comprises parameters that control operation of the ear-wearable device;
obtain audio data from one or more sensors that are included in the ear-wearable device;
determine whether to generate speech assessment data based on the user profile information of the user and the audio data, wherein the speech assessment data provides information regarding speech of the user; and
generate the speech assessment data based on the determination.

16. The computing system of claim 15, wherein the one or more processing circuits are configured to:
determine whether the user has abnormal speech patterns based on the audio data and the user profile information of the user;
in response to determining the user has the abnormal speech patterns, determine a potential type of abnormal speech patterns based on the audio data; and
generate a recommendation based on the potential type of abnormal speech patterns.

17. The computing system of claim 15, wherein the one or more processing circuits are configured to, as part of generating the speech assessment data:
receive a plurality of speech and language skill scores from a computing device;
generate a machine learning model based on the plurality of speech and language skill scores; and
generate the speech assessment data based on the audio data using the machine learning model.

18. The computing system of claim 15, wherein the one or more processing circuits are configured to, as part of generating the speech assessment data:
extract speech features from the audio data;
generate the speech assessment data at least based on the extracted speech features and a normative speech profile; and
output the speech assessment data.

19. The computing system of claim 15, wherein the user profile information of the user further comprises at least one of: demographic information, an acoustic profile of own voice of the user, data indicating presence, status or settings of one or more pieces of hardware on the ear-wearable device, data indicating when a snapshot or the speech assessment data should be generated, data indicating which analyses should be performed on the audio data, data indicating which results should be displayed or sent to a companion computing device.

20. An ear-wearable device comprising:
one or more processors configured to:
store user profile information of a user of the ear-wearable device,
wherein the user profile information comprises parameters that control operation of the ear-wearable device;
obtain audio data from one or more sensors that are included in the ear-wearable device;
determine whether to generate speech assessment data based on the user profile information of the user and the audio data, wherein the speech assessment data provides information regarding speech of the user; and
generate the speech assessment data based on the determination.

21. The ear-wearable device of claim 20, wherein the one or more processing circuits are configured to:
determine whether the user has abnormal speech patterns based on the audio data and the user profile information of the user;
in response to determining the user has the abnormal speech patterns, determine a potential type of abnormal speech patterns based on the audio data; and
generate a recommendation based on the potential type of abnormal speech patterns.

22. The ear-wearable device of claim 20, wherein the one or more processing circuits are configured to, as part of generating the speech assessment data:
receive a plurality of speech and language skill scores from a computing device;
generate a machine learning model based on the plurality of speech and language skill scores; and
generate the speech assessment data based on the audio data using the machine learning model.

23. The ear-wearable device of claim 20, wherein the one or more processing circuits are configured to, as part of generating the speech assessment data:
extract speech features from the audio data;
generate the speech assessment data at least based on the extracted speech features and a normative speech profile; and
output the speech assessment data.
